(19) United States
(12) Patent Application Publication
(10) Pub. No.: US 2014/0330743 A1
(43) Pub. Date: Nov. 6, 2014

(54) TECHNIQUES FOR ENTERPRISE RESOURCE MOBILIZATION

(71) Applicant: IPATH TECHNOLOGIES PRIVATE LIMITED, Chennai (IN)

(72) Inventors: Srinivasan RAMAKRISHNAN, Chennai (IN); Vaithees S. KUMAR, Chennai (IN)

(73) Assignee: IPATH TECHNOLOGIES PRIVATE LIMITED, Chennai (IN)

(21) Appl. No.: 14/197,810

(22) Filed: Mar. 5, 2014

Related U.S. Application Data
(63) Continuation of application No. 12/859,798, filed on Aug. 20, 2010, now abandoned.
Application No. 12/859,798 is a continuation-in-part of application No. PCT/IB2009/005387, filed on Feb. 23, 2009.

(30) Foreign Application Priority Data
Feb. 22, 2008 (IN) 449/CHE/2008

(51) Int. Cl. G06Q 10/10; H04W 4/18

(52) U.S. Cl. CPC G06Q 10/10; H04W 4/18
USPC 705/345

(57) ABSTRACT

An enterprise mobilization system having an EUS which receives user requirement and translates the requirement into a content component and platform independent delivery component. A DSIM receives an information tree based on the content component and translates it into requests for data from at least one data source. The information is contextualized. The system provides an ability to take actions based on the context. All user experiences related to the mobilization are achieved through the concept of end-user services.

This application is a continuation of U.S. application Ser. No. 12/859,798, filed Aug. 20, 2010 which is a continuation-in-part of PCT/IB2009/005387 filed on Feb. 23, 2009, which claims priority from Indian Application No: IN 449/CHE/2008 filed Feb. 22, 2008, the contents of which Applications are incorporated herein by reference.

### BACKGROUND

One can say that this is the age of Enterprise Mobility. In today's world, mobility has become more of a necessity than an option and information is what makes companies run. And as workers become more mobile, there is a high demand for companies to provide information that travels with people as they move around—in other words, information to follow people as they move.

Today, there is an abundance of information and this information is stored in different formats across different sources. Further, due to the rapid progress of technology, there is an abundance of channels across which this information can be supplied to an end-user. For example, information regarding the current points tally of a country in the Olympic games can be supplied to an end-user via e-mail, short message service (SMS), etc. Simply put, technology enables information to be delivered via any channel.

However, the delivery channel through which information is delivered is not always as per the end user's wish. Further, the information that is provided to the end-user is not necessarily based on what the end-user needs most. For example, the CEO of a company does not need a detailed report of what happened in each department every day. In fact the CEO may not even have the time to go through each report. The CEO would probably prefer to receive only an executive summary of the report, rather than the complete report itself. The CEO would also prefer that when he/she is in the office, the executive summary should come to the PC instead of his PDA. If the CEO is traveling, the executive summary should be even more precise and should be delivered to his PDA, because the experience that an end user gets for the same information on a 17 inch monitor is very different from the experience the end-user gets on a small PDA screen. Hence, what is needed is a solution that will understand and identify the needs of the end-user (the CEO in the above example) and give the end-user the information that he/she wants, in the format that the end-user wants, and on the delivery channel that the end-user wants. Hence, the delivery of the information to the end-user should be independent of the source of the data, and should rather be guided by the wishes and needs of the end-user.

Such a solution would ensure that better decisions can be made efficiently because the information that is needed is available at the user's fingertips and not in the office, in the data center or constrained by wired networks.

Further, what is needed is a Unified Information Execution and Delivery Platform that provides rich context-specific information delivery with relationship between content, people and actions anytime, anywhere and to anyone through any device. What is also needed is that actioning tools be made available when the information is delivered, i.e., when information is made available to the end-user, the end-user would most likely want to take actions based on the delivered information. For example, a business manager may periodically receive sales reports of various regions on his PDA. The business manager would most likely want to discuss these reports with the regional heads. Hence, a solution is needed which would provide the business manager with the capability of connecting to his regional heads (possibly by a simple click on the PDA or by a simple voice command), instead of searching through the telephone directory for the telephone numbers of the regional heads. Along with the above capability, the solution should provide the regional head whom the business manager is calling, relevant information (sales report) so that the business manager and the regional head can be on the same page and come up with an action plan.

Importantly, activities that the Enterprise users perform are dependent on communication and information. Information is key to decision making; whether customer wants to buy a product or business wants to procure specific quantity of raw materials or any other activity information can determine outcomes. Communication is an important channel for conveying information as well as for enabling interactions whether its group decision making or purposeful social interaction and in many other functions.

Until very recently the combination of mobility, information and communication was pseudo-fictional. But with the explosion of mobile devices and multiple-modes of reachability and connectivity—whose adoptions are fastest, that becomes a reality. Though developing along separate paths, mobile communications and Internet have started to converge, which provides newer ways to execute business activity—like utilizing the power of SMS, MMS, Mobile eMail, PTT and etc integrated with wireless internet services like 3G, GPRS and other technological innovations like GPS, Location awareness and Presence sensors [like RFID tags].

But ‘Enterprise Mobility’ is not only about mobile users and their mobile devices. It's a good starting point. But in a increasingly complex and competitive business environment—due to factors well known like rapidly disappearing differentiators, the need for higher visibility, exploding customer choices, changing lifestyle trends and shrinking world, the list is too long to go—it's the way ‘competitive responsiveness’ of a business in terms of ‘Speed’, ‘Consistency’ and ‘Effectiveness’—to address opportunities and threats, makes a business succeed or fail.

In this scenario, where business can peak or break, based on ‘perception of momentum’, there is a dire need for ‘real-time and on-demand enterprise’. Multi-pronged strategies are being devised by enterprises to take on these challenges without loosing momentum and continuity. One of the key strategy is ‘Enterprise Mobilization’—the right kind of mobility. It's about mobilizing all the key resources of a business and make optimal usage of it by providing ‘right informatin at right time’ to its stakeholders, anytime, anywhere.

Mobility clearly has a significant impact on an Enterprise. Quite often, employees in the move may need access to information stored in client/server or Web-enabled applications, yet cannot access this information, leading to significant productivity losses. This often leads to a discussion around “mobilizing” the back office applications where this information is stored, with the desired result of enabling workers to have access to information stored in ERP, CRM, Accounting and other traditional client/server or Web enabled applications. While this may seem the obvious way to derive incremental value from these valuable IT assets, this approach fails to deal with the realities facing the mobile worker.

End user empowerment enables employees to take back office systems to the point of interaction with the customer, no matter where their customer might be. As a result, customers receive a higher level of service and exhibit a higher level of satisfaction and loyalty to their supplier. Employees achieve higher productivity and greater job satisfaction. Mobility, therefore, is a key competitive differentiator and business imperative. But managing mobility is different and requires new tools and processes.

Enterprise Mobility is currently characterized by many different mobility schemes, all hard to link together. The consequence is reliability on ad-hoc applications and multiple quality and life-cycle issues. As a result, the management of mobility is very complex and cost control is a constant issue. End users are unhappy, and their productivity suffered; and mobility solutions consistently fail to deliver on the business case by which they had been justified.

Enterprise are starting to recognize that ‘Mobility’ is not just mobile enabling a particular application, rather delivering a set of composite services and experiences based on user ‘employee’ business process in a given context; that takes advantage of existing applications and provide enterprise-grade scalability for future expansion.

The disclosed teachings and the vision of Enterprise Mobilization redefines the possibilities and choices for communication and collaboration within and outside the Enterprise and helps it meeting the changing dynamics and challenges of globalized business environment; by making it more dynamically distributed and more accessible for the stakeholders across channels and devices.

Mobilization Principle 1:

Enterprise mobilization should diffuse networks by eliminating network boundaries (or at least make them invisible to users) and enable real mobility spanning wired and wireless domains.

It would be surprising to know that ‘50-70% of office space is unoccupied during normal business hours (Source: International Telework Association and Council). By 2011, more than 880 million—a major part of enterprise workforce will be mobile (Source: IDC 2006). Where are these people? Some are elsewhere in the building or visiting another site. Others might be working from home, in customer places, on the road, and generally be on the move. With, ‘Changing business dynamics’ combined with the widespread adoption of telecommunication, wireless and various other convergence of technologies like internet and mobile communications, this trend will only increase.

There are other factors like newer transport modes—France's TGV bullet trains clocks 400 Kmph, In countries like India and China, low cost airlines, mass transport systems, and cheaper energy efficient cars are changing the business trends.

In this scenario, how can organizations ensure that time & distance away from ‘My Desk’ will not act as a barrier for productivity? Is there a best way to ensure the continued availability of processes and systems in general and information in particular to End users, in ways that are natural, convenient and effective?

Since the surge of both internet and wireless technologies in the 1990s, enterprises have tried various ‘mobility’ solutions to address those questions. But as we take stock now, it seems they have just scratched the surface of enormous and ever-expanding possibilities. As key standards and technologies mature and new innovations reach the market, it's time to raise the bar on what constitutes real mobility for the real-time enterprise, making it completely on-demand and accessible on-the-move.

What is needed is a consistent, quality user experience that requires convergence of business applications and resources, which can reach out to users or let users access in any which way they can, either wired or wireless. This will lead to seamless experience that transcends traditional network boundaries. Users can roam from floor to floor in a building, across the city and around the world. Wherever they go, they will enjoy the non-disruptive access to their business resources, with little or no noticeable impact as they move around or cross networks.

Mobilization Principle 2:

Enterprise mobilization is more than just having some way to stay in connect. It is about ability to provide information and services to the enterprise users irrespective of when and where they are.

Mobilization Principle 3:

Enterprise Mobilization is not one more software solution which supersedes or obsoletes other existing solutions and packages, instead it is a software fabric—that coexists and act as a façade—connecting enterprise resources to users in newer ways, bringing in productivity gains by providing for newer execution capabilities and possibilities.

Today, Enterprise Mobility exists in a highly fragmented world of multiple devices, multiple phone numbers, multiple mailboxes, multiple security procedures, device-dependent interfaces and disjointed communication applications. These scenarios are further complicated by the proliferation and adoption of newer devices running under a handful of different operating systems by the user community.

In this scenario, it's very easy to believe with having laptop or PDA or multi-functional Mobile phone (having mail client, address book, conferencing and rich multi-media); that mobility has been achieved because the business has wireless communication of some sort. But in reality, this is far too narrow a definition. Sure, wireless communications enable people to get away without losing touch, but are that enough? Communication is one of the aspects of mobility that will keep business in reach with their employees; there are other factors like, modes of mobility and, difference in levels of connection and communication etc.

At the other end of the spectrum there exists, disparate business applications, groupware solutions, and other business process and workflow related frameworks. Each one serves its own purpose or sometimes cross purpose. Far too many integration specifications came and went and are still coming. As more investments happened in the past decade on IT, it has become a complex scenario for both IT and Users, by end to the organization. As users become more familiar with newer technologies on their personal computing space, the demand on IT to adopt those too also becomes realistic. Managing applications, training and supporting users and their access points has become the primary job of IT, leaving them less time to focus on improvising and re-engineering the processes to augment productivity.

When we look at this, the proliferation of devices and applications, we can understand why Enterprise Mobility is stagnated at the device-to-application (in some form) access level.

To be useful, all these could be leveraged for better, enterprise must create a unified world of applications and communications which is natural, convenient and simple for end users. This should let Enterprise capitalize on the growing trend towards multiple devices and multiple connectivity options available through infrastructural advancements and the existing investments made on IT resources.

By providing the ability to perform business functions at the edge, Enterprise can bring in more productivity and be real-time business.

What is needed is a treatment of User's need for information in-context, rather than set of features i.e. focusing on user's experience rather than application' usability. All those IT resources should be categorized into information and communication resources and exposed to the user as granluarized services which should be consumable from whatever access point they are in, whenever they want, in whichever form they need.

Mobilization Principle 4:

Enterprise Mobilization is more than discrete mobile services. It should capitalize on existing applications and systems, and multi-purpose access, enabling users to not just connect, but fully engage from wherever they are.

Today, enterprise users carry a host of portable communication devices, laptops, pagers, PDAs, multi-mode mobile phones, two-way radio phones, and, music and video players, mobile readers and etc. The future looks more engaging for the User, where it's going to be ‘anything with a processor will have a radio along’. Just watch business travellers unloading their pockets and briefcases at airport security it will show more accurate picture of what's coming tomorrow.

Most of these devices have common characteristic i.e., multiple connectivity enabled in general, and connectivity through Internet in particular. With all these innovative devices and communication capabilities, what's still incongruent? The way the Enterprise mobility is, it still is discrete mobile services [eMail access, website, or some white spaced application] at the best and none at all in its worst.

Organizations need to integrate it's availability across a broad range of business activities and user devices, and converge asynchronous communications (such as e-mail, voice mail, short message services) and synchronous communications (such as IM, voice, video and application and other application/package resources), so that business users can engage, not just connect to perform their business roles.

With this broad range of attributes in place, the network can deliver critical and time-sensitive information precisely when, where and how users need it. For example, imagine a customer support centre being able to locate and engage the specialist who can best meet the client's service needs, drawing on a geographically distributed pool of specialists. Imagine a supply chain management application that brings the right people together anytime, anywhere to resolve a supply or delivery issue. Or a collaboration application that makes it easy for dispersed creative teams to spawn new innovations. Or a Senior Corporate Executive having a virtual secretary helping him keep track of ongoing business—like monitoring activities, governance related issues and etc., letting him keep his focus on building exploring new opportunities.

Additionally, scenarios such as these need to be enabled, and business functions made intuitive and mobilization experiences should be easy to use, applying technology to drive and deliver systems [information and communications] ever closer to the users, which in turn will help enterprises to recreate the in-person experience.

Mobilization Principle 5:

Enterprise Mobilization is not about information deluge or overkill in another form, the users are not just connected and engaged. They're in control.

Never in the history of mankind, had so many forms, formats and modes of access to information through variant media forms existed. This ‘over stimulation’ makes us believe ‘feeling part of action’. The hyperactive culture of the Internet Age also makes us believe that we must be constantly available to everyone, all the time. Though having its purpose and serving good at some situations, the overall they take toll on and individuals on ‘time and efficiency’.

This is truer in business where ‘switching off’ is not an option for most stakeholders. The understanding is that productivity will suffer if collaboration and connection is not instantaneous and on demand. In reality, mostly it has opposite effect. This kind of never ending ‘being online’ and ‘connectedness’ can stifle the same productivity it aims to generate. When employees can be interrupted at anytime, gone is the focused opportunity to research and reflect, conduct day-to-day activities with purpose, and dedicate one's focus to the task at hand.

Our vision of Enterprise mobilization gives users control over how and when their information services should follow them and when to leave them alone, without overrunning the users. End users enjoy a high degree of control over what they want, when they want and how it gets served to them. They would have tremendous flexibility to personalize their services to suit their work requirements, schedule, tasks and preferences.

In other words, as organizations are provided with ability to avail their unified business task execution capability to the users on-demand wherever and whenever; at the same time users having control over how they want to use and benefit from it.

Mobilization Principle 6:

Enterprise Mobilization requires newer model of scalable and dynamic differential security without compromising on the core benefits of providing access to users and their devices anytime, anywhere.

As with any other format, Enterprise Mobilization must be secure everywhere. The very openness that makes mobilization useful and valuable would seem to make it equally vulnerable.

The issues is not only the device and data, it's more than that. As cross domain resource integration is not only across the enterprise it could be horizontally across various enterprises—for example a Contact centre employee while addressing a customer call might need access to customer data from inside and product details and warranty details from original manufacturer, and delivery details from logistics provider. Though in most cases it might be primary domain and primary business resource, it can cut across domains, and adding channel, protocol, and user role to this soup it looks like a complex endeavor.

But thankfully, with the stringent protections and security policy enabling frameworks along with best of breed technologies like single sign-on, Identity management and, control systems and etc., while preventing malicious access, the users can be provided with authorized and secured access across domains. The challenges can be resolved with a full array of security solutions that are easy to deploy and interoperate seamlessly with existing network components such as routers, firewalls, and existing authentication mechanisms and myriad security policies.

In other words as enterprise resources are granluarized, security and access control also needs to be similarly treated. Once that occurs the challenge of providing secured access will become simpler. Each resource request from the end user should be addressed differentially as whole and parts; taking those variant attributes and context in to account, while validating and authenticating. Internally the user' role, contextual resource, channel, device and, protocol and etc, should be evaluated against security principals and permissions.

The other requirements of full-fledged security delivery, like secured communication channels, encryption standards, certificates and, secured access keys and etc, are already available and most of them exist within enterprise IT infrastructure.

Because of the granular nature of mobilized services, which are also contextualized and focussed on experience rather than feature sets alone; they will require a differential security paradigm—for example; for an user, from a device, through a channel accessing across different domains or vertical business resources, where the security should be multi-scalar addressing access and control policies of each resource, device, protocols, and user's business function role.

In summary, the Enterprise should embrace this broader perspective of mobilization [in turn true mobility], so that, they can realistically achieve their stated goals of improving productivity, reaching new markets, enhancing stakeholder values, addressing the constant and unexpected changes in business environment, and keep delivering superior customer care without compromising. Collectively, the outlined principles point to a new model of communicating and collaborating across dynamic and multi-location on-demand enterprise: a consistent, reliable, and secure communication experience for all stakeholders—anytime, anywhere and on whatever device.

The disclosed teachings and the exemplary implementations are based on Unified Information Execution and Delivery Model—that will play a critical role in delivery of Enterprise Mobilization which satisfy aspects and attributes of the above goals.

### SUMMARY

To achieve some of the objectives and goals described above, there is provided an enterprise mobilization system comprising EUS which receives user requirement and translates the requirement into a content component and platform independent delivery component; and DSIM which receives an information tree based on the content component and translates it into requests for data from at least one data source. The information is contextualized and the system provides an ability to take actions based on the context. The user experiences related to the mobilization are achieved through the concept of end-user services.

Other aspects, techniques of implementation as well as program products that implement these systems and techniques are also aspects of the disclosed teachings.

### BRIEF DESCRIPTION OF THE DRAWINGS

The above objectives and advantages of the present invention will become more apparent by describing in detail preferred embodiments thereof with reference to the attached drawings in which:

FIG. 1 shows an overview of context based information.

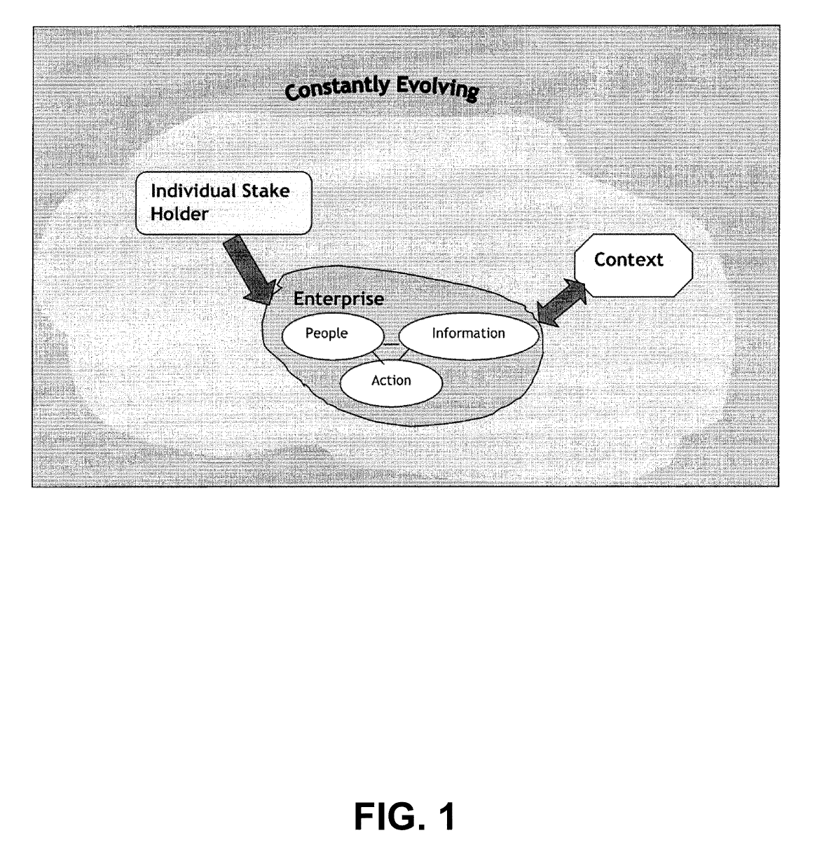

FIG. 2 gives an example of a system that provides an enriched mobility experience on various communication channels.

FIG. 3 shows further details of RTE and its interaction with other components.

FIG. 4 shows a seven layer architecture for a system embodying aspects of the disclosed teachings.

FIG. 5 shows components of an exemplary platform on which the aspects of the disclosed teachings are implemented.

FIG. 6 shows an overview of an exemplary deployment of the platform of FIG. 5.

FIG. 7 shows a block diagram that illustrates configuration of an IAW solution

FIG. 8 shows a flowchart illustrating an exemplary example of the deployment process.

### DETAILED DESCRIPTION

To achieve one or more of the above objectives, the disclosed teachings provide a system and method for managing an enterprise and providing a unique mobility experience. An exemplary implementation of the disclosed teachings provide a middleware platform that can provide mobility experiences which includes providing highly context specific actionability using the communication/mode of choice.

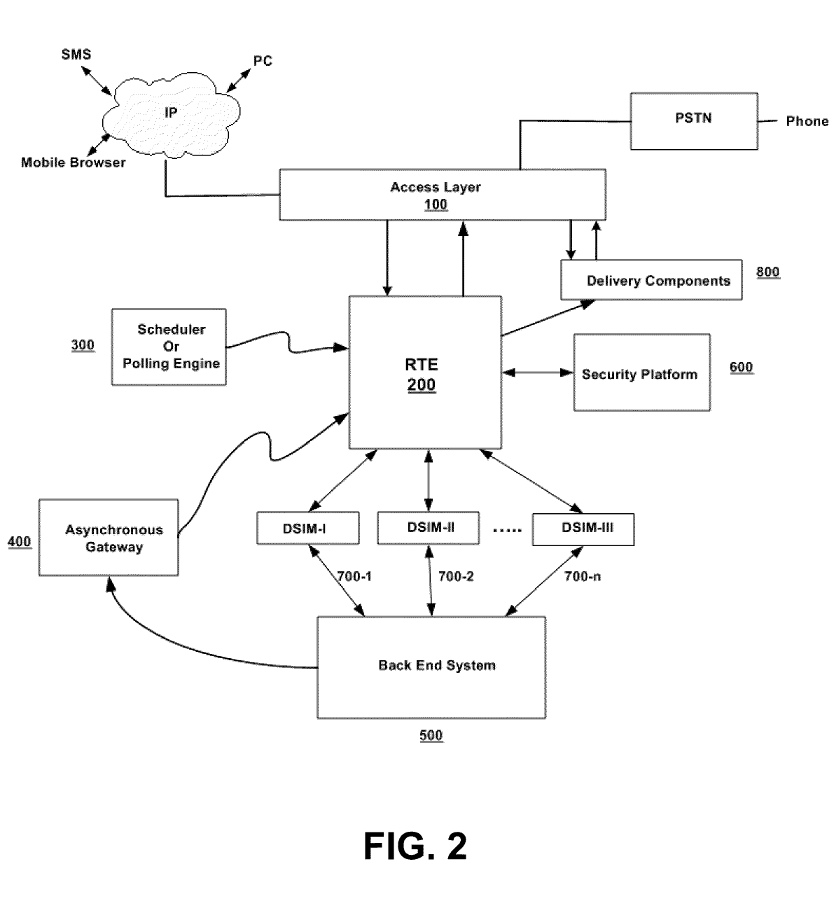

FIG. 2 gives an example of a system that provides an enriched mobility experience on various communication channels. In FIG. 2, the Access Layer 100 establishes communication between the Run Time Engine (RTE) 200 and the destination devices such as a PDA, a personal computer, etc. The Access Layer may include a web server such as an IBM WebSphere, or a voice gateway such as a CISCO 5300 or Vegastream. For example, this layer could include Message Queues as implemented by MS or IBM, Audio and Video Streaming Server, FTP, SMPP and SMTP Gateways. However, the components of the Access Layer are not limited to these components and many more components that can establish communication between various destination devices and the RTE 200, may be used.

FIG. 2 also includes a RTE 200 that is responsible for the execution of the end user services (more information on the composition of the RTE 200 is described later). The RTE 200 represents the primary component of the mobilization platform. The RTE is implemented as a web application. The RTE receives requests from interactive channels like PC/Voice/Mobile browsers, PC/Mobile applications, Scheduler/Polling Engines 300 and Non-Interactive Service Gateway 400. The RTE has implementations of functionality for communication, personalization, metadata management. RTE uses DSIMs (Data Source Integration Modules) 700-1,2 . . . as a means to integrate to external data sources. RTE's primary job is to process end user service (EUS) execution requests, get it processed by either On-Server Actions or by DSIMs. RTE also interfaces with delivery components/templates to transformation information for delivery/presentation. The RTE 200 is also connected to the Scheduler/Polling Engine 300 and the Asynchronus Gateway 400.

The Scheduler/Polling Engine 300 periodically polls/triggers notifications and causes execution of a certain periodic EUS. The RTE 200 maintains a database of EUS execution schedules. The EUS execution scheduled provide the information from back-end systems (500) to perform notifications. The job of scheduler is to periodically run the scheduled EUS′ The Asynchronous Gateway 400 is responsible for triggering an EUS asynchronously, i.e., due to an asynchronous/random event. The asynchronous event may be generated by the back end system 500.

The back end system 500 is the source of the core data for the enterprise. The back end system 500 may include databases, standards based web-services, file systems, legacy back end-systems, etc. While the back-end system itself is not configured the disclosed system integrates to it. In that sense the IPath Configurator, is able to identify and present all data sources (and associated functionality exposed by them) existing in a business domain. The RTE 200 connects to the multiple heterogeneous sources of the back-end system 500 via DSIMs 700-1 . . . 700-n. DSIM refers to Data Source Interface Modules that are “thin layers of integration” between an App in the system and third party data stores or information services (standards based web services for example). Requests to DSIMs are in terms of the Information Tree (which itself is a representation of all information in solution domain from a business perspective). The DSIM translates this to a native request based on the specific type of DS it connects to (for example, convert to a database request if DSIM is interfacing with an RDBMS). DSIM uses BER (refer later comments for how EUS′ are executed) to process request; is responsible for transforming output of BER to a standard XML in the system. DSIMs may be thought of as interpreters, all dealing with English from an end-user perspective but interfacing in the background with German, French, Greek, information sources The data is delivered to the destination device being used by the end-user via the access layer 100. The RTE 200 provides this data to the access layer 100 thru delivery components 800.

A delivery component 800 may be a dynamic template or templatized applications. A delivery component is a block of software logic that generates either a browser experience (HTML, VXML or xHTML page) or generates code set (in this case it may be thought of as a templatized application. The template evaluation is based on primarily 3 types of information—user session information, state of EUS execution information and configuration information (which is the application data for the system). Connection to access layer is outside delivery component. Either the delivery component execution is happening from within an access layer connection context (say, a user request from a PC browser that comes through a Web Server; the template itself represent a dynamic web page) or is used as a parameter to an access layer connection (say, the template output determines a HTML body of an email and is used by an On-Server Action that establishes connection with an SMTP server to push mail)

A security platform 600 may also be connected to the RTE 200.

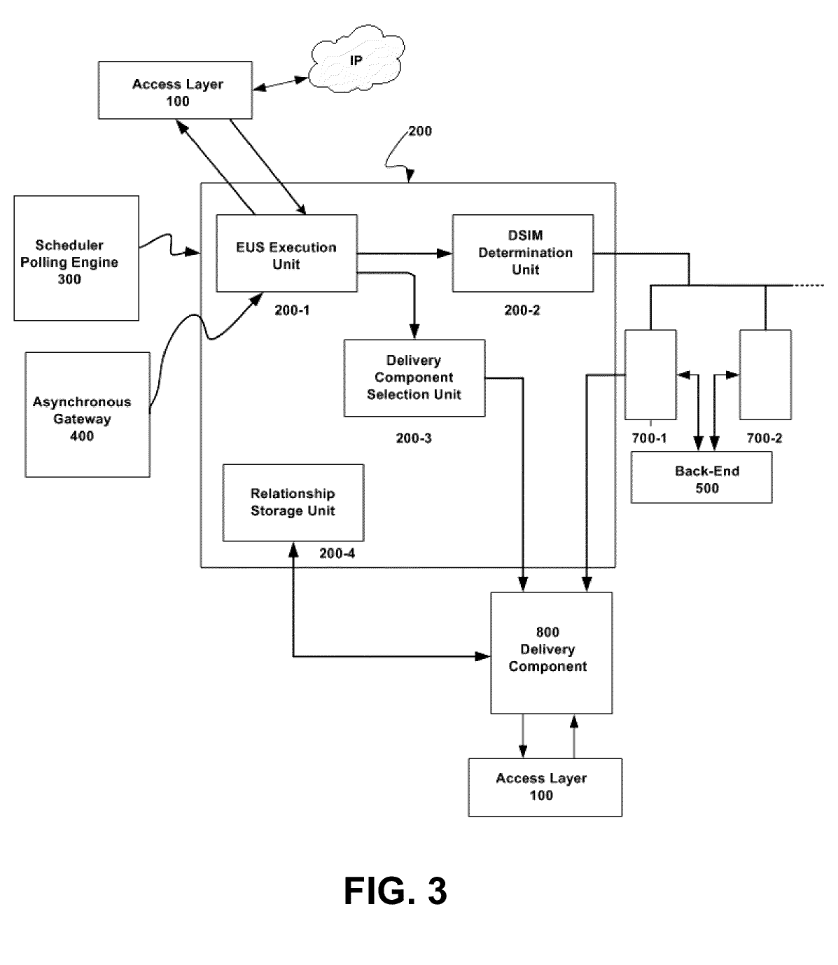

The disclosed teachings will now be described in detail with reference to exemplary scenarios. A first exemplary scenario is now described. Let us say, Bob (an example for an end-user) wants to track e-mails from XYZ. Inc. Bob can use his Personal Workspace (may be available as a portal on a device Bob is using) for the above service request. The tracking email service can be provided as a link in Bob's Personal Workspace. The above service request could be a one time request or it could be a personalized request that is run periodically, i.e., it could be a scheduled service. The personalized request can be stored in Bob's Personal Workspace for Scheduled Services. As seen from FIG. 3, Bob can make a one time request for tracking emails through Portal Services available in Bob's Personal Workspace or the Scheduler/Polling Engine can run Bob's personalized service request periodically (for example daily or every two hours) by polling the RTE 200. It should be noted that if Bob makes a one-time request from his Personal Workspace, which he may be accessing on his PDA, the one-time request is received by the RTE 200 through the Access Layer 100.

The above request for tracking e-mails from XYZ.com is supplied to the RTE 200, which then executes the EUS “Check Mail”. RTE comprises of a service execution gateway, a service execution manager, application data managers (for handling configuration data of different kinds—EUS, BER, IR, DS, TR . . . ), On-Server Actions (OSA), DSIM Selection unit, OSA selection unit, Environment Manager, Personalization Manager. The EUS Execution Unit 200-1 is responsible for executing a service request from the end-user. The EUS Execution Unit 200-1 may be embodied as a hardware unit or may be a software code that defines the various EUS′ that the system has to offer. For example, the EUS Execution Unit 200 may store the software definitions for each of the multiple EUS′ that the system has to offer.

A technique similar to “if” or “switch case” blocks exits to process a request. However, they do not bear a one-to-one relation with the number of EUS definitions itself. The conditional happens around EUS type because there are some nuances to how it is processed based on whether it is an information request for interactive/portal processing, notification processing, On-Server Action execution.

As seen from the description above, the service request from Bob comes to the EUS execution unit 200-1 via the access layer 100. The EUS execution unit 200-1 first checks if an input is required from the user. This check is performed based on the definition of the EUS being requested. If no inputs are required (in this case it has already been specified that e-mails from “XYZ.com” need to be tracked), the EUS execution unit 200-1 forwards the request to the DSIM determination unit 200-2

An EUS execution is being requested by user or scheduler. EUS has content/back-end info and delivery/presentation info. Content/Back-end info comprises of a Information Request. This in turn comprises of one or more user input blocks, a Visual Representation (a combination of information details) and a back-end request(BER). The BER has the Data Source (DS) associated with it. The DS has a type information that is tied to a particular DSIM.

Now, the DSIM determination unit 200-2 determines the DSIM and the back end request (BER) to use for executing the EUS “Check Mail”. For the present exemplary scenario, the DSIM determination unit 200-2 determines that it needs to connect to the Mail Server (determined based on back-end integration details in the service definition for “Check mails” from Mail server access based on a specific protocol like PO3 or IMAP. The particular IMAP_POP3 DSIM that is asked to execute the Information Request. The Information Request has an associated Back-End Request and the Back-End Request (BER) has an associated Data Source or DS (address and connectivity details for mail server, in this case). The DSIM uses DS information to establish connection to mail server (the connection itself may not be established and disconnected on a request-to-request basis!) and then the information in BER is used to make appropriate protocol request and obtain data from mail server and uses an appropriate DSIM 700-1 to communicate with the Mail Server, which is part of the back end system 500. The DSIM 700-1 fetches the data from the Mail Server and may convert it to a format that is being used by the RTE 200.

Once the data has been fetched from the Mail Server, a delivery component to be used for delivering the fetched data is determined. The delivery component to be used for delivering the fetched data is selected by a Delivery component selection unit 200-3. The Delivery Component selection unit 200-3 has a plurality of delivery components at its disposal.

Personalized notification services have preferences on specific channels of delivery—email, SMS. Today it is a simple “toggle channel of delivery” capability available; With minimal extension to data stored, we can provide dynamic delivery decision making (such as, before 9 am, sms me; between 9 am and noon email me.) In the current exemplary scenario, if the data has to be delivered on a phone that Bob is using, the Delivery component selection unit 200-3 selects a delivery component 800 that delivers the data on a phone from a plurality of delivery components that may be available. After determining the delivery component, the Delivery component selection unit 200-3 transfers control to the selected delivery component and initiates delivery action of the EUS that is being executed.

According to the current exemplary scenario, the selected delivery component 800 corresponds to Bob's phone. The selected delivery component 800 determines the context relations and presents actioning around people and information, i.e., —Bob's phone will ring and he may get a message such as “This is your system calling. You have a mail from paul@xyz.com. Received at 9:30 am this morning.”. The selected delivery component 800 determines the necessary information that needs to be presented to Bob. The determined information may be for example, links to related services such that Bob can take actions using those links. An action that Bob may take using those related links would trigger another EUS in the RTE. For example, Bob may be provided with an option to check project status, which is a related action. The delivery component is able to determine this related action based on the context of the original EUS “Check Mail”. “Check project status” is a related service because when mails are being accessed, project status information may be requested.

Providing links or the capability to take a related action is made possible by storing relationships between different End User Services. In the above exemplary scenario a relationship was stored between “Check mail” and “Check project status”, which are both End User Services. These relationships are stored in the Relationship storage unit 200-4. Before delivering the fetched data, the delivery component 800 determines if any relationships are stored for the EUS “Check Mail”. Now, the relationship storage unit 200-4 may store a relationship between “Check Mail” and “Check project status”. Therefore, the delivery component 800 is able to provide Bob with the ability to execute the “Check project status” EUS.

In response to the related links/actioning capability presented to Bob, Bob may speak “check project status”. Thus, Bob has requested execution of another EUS. In other words, Bob has triggered a relation action. The request is again routed through the EUS execution unit 200-1. In this case, the EUS execution unit 200-1 may determine that a project ID is needed and may request the project ID via the Access Layer 100. Once Bob enters the project ID, the EUS execution unit 200-1 proceeds with EUS execution as described above. In this case, the delivery component 800 in conjunction with the access layer 100 proceeds with delivery action and may deliver for example, a VXML output that is used by Voice Browser for speaking out project status details.

Another exemplary scenario is now described. In this exemplary scenario John is a senior portfolio manager, responsible for over 50 different portfolios. John is watching CNBC market report just after more than one leading vehicle manufacturer has reported serious losses. John estimates a domino effect in coming months on some software portfolios under his management, doing significant development in the auto space. John goes to his PDA to pull out information on number of customer portfolios affected by downturn in auto sector. In the present exemplary scenario, John himself found out that one of the leading vehicle manufacturers has reported losses. However, John could be notified of this issue by the Asynchronous Gateway 400, which is communicating with the back end system 500, i.e., when an event that is of consequence to John occurs in the back end system 500, the Asynchronous Gateway 500 can present this event to John through the RTE 200. The RTE 200 (via the delivery component in conjunction with the access layer) would then provide John with related information such that he can take the necessary actions, if any.

Going back to the exemplary scenario in which John finds out that a vehicle manufacturer reported losses. John goes to his personal work space on his PDA in which John has his personalized “Impact Check Service”. The “Impact Check Service” could be a service that lists customers whose portfolios have more than x % invested in a specific set of companies. Further, John could have personalized this service for a particular set of companies such as Ford, Hyundai, etc. Once John requests execution of this EUS, the service request is routed to the EUS execution unit 200-1, which runs the personalized service against the portfolio management DB.

A similar sequence of events takes place as described in the exemplary scenario with Bob. Delivery action is now triggered by the RTE 200. In this case, the delivery component 800 may prepare a presentation of retrieved customer data, determines context, and includes 2 additional EUS′ along with the customer list. The two additional EUS′ that are delivered or presented for John to execute may be “Connect to Customer Relationship Manager for Portfolio” and “Get Portfolio Details for Customer”

Delivery templates constitute delivery components. “Impact Check Service” defines the context. The 2 additional services listed as part of the delivery are related to “Impact Check Service”. As noted earlier, the system provides John with these related EUS′ because the relationship storage unit 200-4 stores a relation between different EUS′.

John sees listing of customers impacted. He selects 1 or more customers and clicks link to select related action. John picks one of 2 possible related actions. In fact John triggers a “service orchestration”, which is sequenced execution of EUS′. For example, John may trigger an EUS in which the RTE 200 pushes details of the portfolio belonging to customer selected by John. The EUS sequence may further proceed by establishing a live communication connection with the regional manager that is in charge of the selected portfolio.

An orchestration is a pre-defined sequencing of EUS executions. The orchestration definition is itself exposed as a EUS and may be available for execution in the context of any other EUS execution. In this case, the orchestration may involve the following EUS sequencing: (1) For selected list of customers and portfolio holdings of interest, fetch holding information, (2) Fetch the list of RMs (email and phone information included) associated with these customers, (3) push details obtained in (1) to the RMs, (4) trigger a voice conferencing service that connects current user with RMs. Orchestrations are similar to MS Outlook Message Rule—on mail received from x, copy message to folder y, delete original message.

An exemplary implementation of the disclosed teachings may be able to deliver rich context-specific information with relationship between content, people and actions anytime, anywhere and to anyone through any device. The delivery of the context-specific information and related actioning is made possible by storing relationships between different EUS′. As such, an enriched mobility experience can be provided to the end-user.

The key to providing related action links is the storing of the relationships. Relationships may be explicit or implicit. Explicit relationships may Share Scope, Share output details, may be linked, may have shared information context, etc. When two different EUS′ share at least one parameter that is input, the relationship is said to have shared scope. For example, an EUS “Sales for region X” and a related EUS “Competition info for region X” may share at least one same input parameter.

Looking at regional sales performance for a particular period and particular product; need to look at performance for previous period for same product or get the sales people performance for same period and product line. When the output for an EUS provides the input for another related EUS, the two EUS′ have a relationship that shares output details. For example, an EUS such as “Show all messages” may deliver messages from X number of people. Now a related EUS “Payment history for selected user” depends on an input, which may be selected from the output of the EUS “Show all messages”, i.e., one of the X numbers of people. Two relationships may not have an input or output sharing and may still be linked. For example, a relationship may be stored such that whenever the EUS “List financial portfolios” is executed, a link service may be triggered that provides a link to the stock market to the user. A relationship may also be based on a shared information context—Represent personalized relationships; service relationships uniquely seen by individuals.

While there is a preferred accepted way of working in a domain, individuals may have particular response patterns (contextual service selection preferences) that are unique. Preference on related service selections in context may be based on specific individual's hypotheses on correlations; if x happens, there is a possibility that y is a reason; proceed with standard investigation if y has been eliminated as a source of problem.

Today relationships are explicitly defined using configurator. In the future “dynamic” relationships are believed to be possible. Relationships also could “dynamically” evolve over time based on user transactions. The current state of data definitions already supports such a capability. Only our interfaces need to be modified for the purpose. What this means is that, in the exemplary implementation, user has access to any end user service in catalogue, in the context of a particular EUS being viewed. If system captures this detail, there is the possibility of storing this as a service relationship; the fact that EUS B was selected in the context of EUS A by user X may have potential as a useful contextual relationship for a whole set of their users.

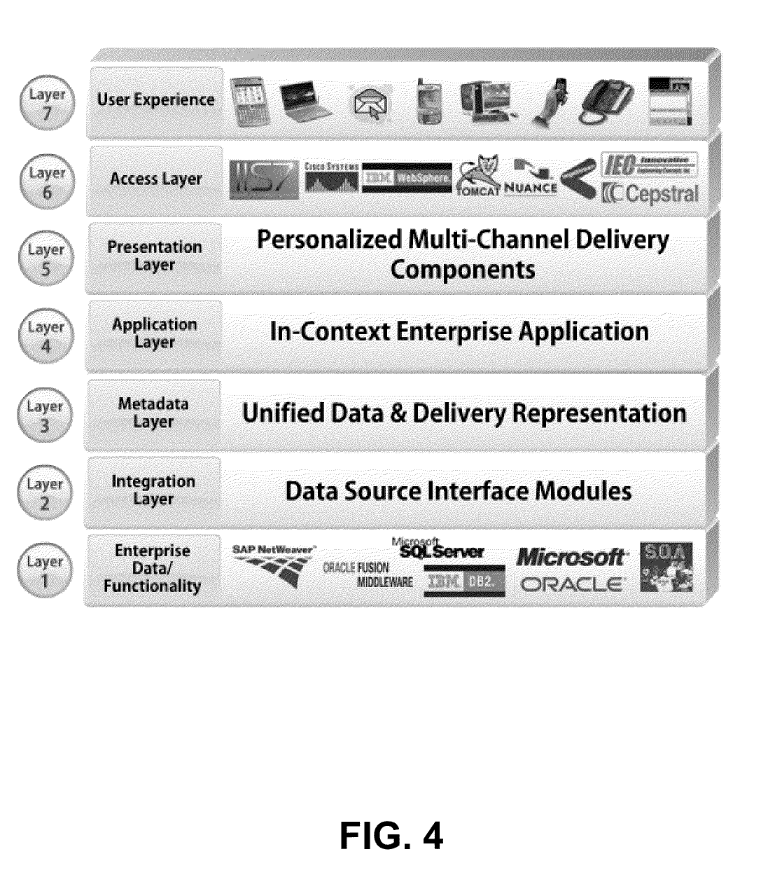

FIG. 4 shows a seven layer architecture for a system embodying aspects of the disclosed teachings. For convenience, this system is referred to as iAllways.

7-Layer Architecture

The lowest layer, Layer 1 is an Enterprise Data Layer. Represents various Enterprise Data Sources (Data stores, Message stores, Mail stores and Content stores, etc) and the functionality therein. Organization of data sources for iAllways Mobilization access is part of this layer.

The second layer, Layer 2, is the Integration layer or the Data Source Interface Layer. It consists of Data Source Adapter software components—Data Source Interface Modules (DSIM) that provides interface between Enterprise Data represented in Layer-1 and iAllways System. These components handle data exchange requirements (Connection, Parameters and etc) and specifications (Authentication, Security and etc) for each data source dynamically.

The third layer, Layer 3, is the Metadata Layer or the Unified Data & Delivery Representation Layer. It deals with Metadata representation of enterprise data in iAllways System including normalizing data, discovering relationship, and description for mobilization; also includes representation of various delivery templates for mobilization.

The fourth layer, Layer 4 is the Application Layer or In-Context Enterprise Application Layer. This Application Layer uses the Repository of iAllways End User Services (EUS) [organized by ‘Business Context’ and relationships]—generated from Unified Data and Delivery Representation (Layer-3). Also this handles the general application functionalities viz., content delivery, session management, and etc.

The fifth layer, Layer 5, is the Presentation Layer. It Consists of Personal Work Spaces (PWS) and presentation and or delivery components personalized for various modes of access and variant channels of delivery. This provides for unification of delivery based on ‘Business Context’.

The sixth layer, Layer 6 is the Access Layer. This serves as primary host for iAllways System. Also provides access integration of iAllways System through various hardware and or software servers and services.

The seventh layer, Layer 7 is the User Experience Layer. EUS experiences for Users and devices through various modes and channels (web pages, mobile pages, messages, mails and other forms of notification in various modes—push, pull and on demand) are provided. Also on-device or plug-in applications provides integrated/enhanced user experience of iAllways System.

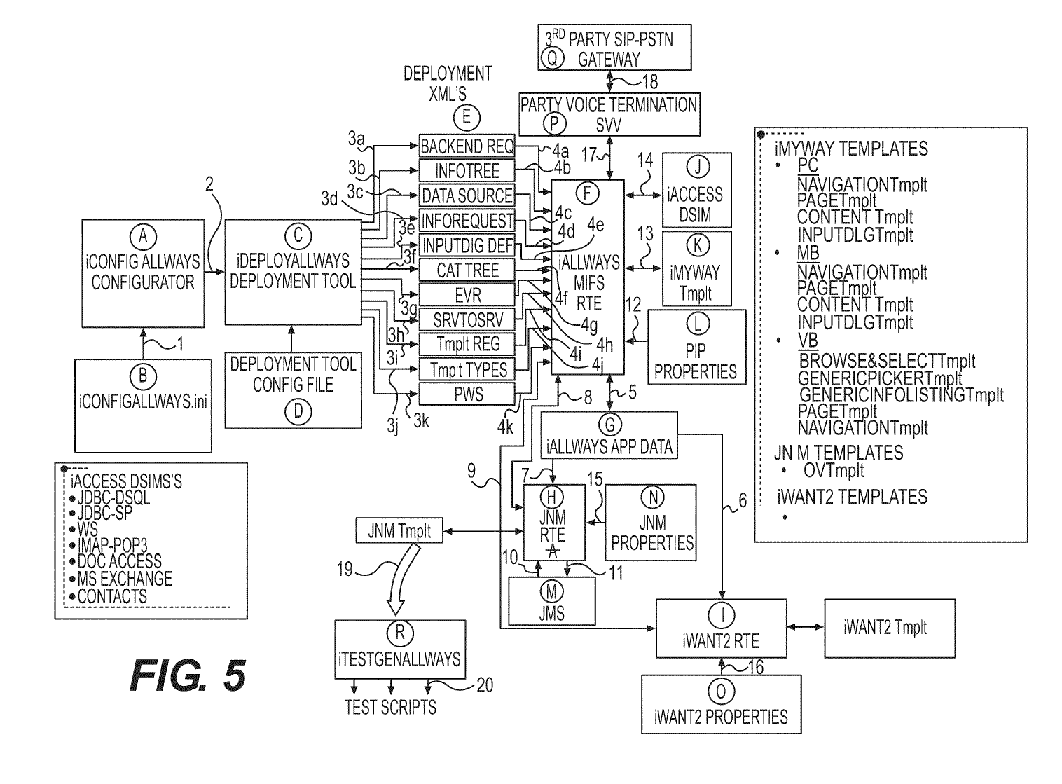

FIG. 5 shows components of iAllways Platform that is an exemplary platform on which the iAllways system is implemented. The following table shows the core components and list the functionalities provided by each of the components. It should be noted that the terms that are used for various components are for ease of understanding and should not be limiting in any way.

### Overview of Core Components

| Component | Functions |
|---|---|
| iAllways | Information Tree definition and configuration |
| Configurator | Datasource Mapping |
| | Service Definitions and Relations |
| | Usergroup and Personal Workspace |
| | Packaging |
| iDeployAllways | Solution validation |
| | Deployment package generation |
| | iAllways Core Platform API Integration |
| | User-level Personal Workspace Packaging |
| iAllways RTE | Service Request and Response Manager |
| | Service call handling |
| | Dialog management |
| | Core Administration management |
| | Personalization |
| | Logging and Performance management |
| | System handling |
| | Run-time services and communications |
| | Channel and device communication |
| | HTTP Gateway manager |
| | Session management |
| | User Authentication and management |
| | Security |
| iAllways | Channel specific presentation properties - pre |
| Template | configured and customizable |
| Library | Input Template |
| | Presentation Template |
| iAccessDSIM | Datasource Integration Modules |
| | Handling Backend Request and Responses |
| JNM RTE | Scheduled Service management |
| iWant2 RTE | Asynchronous gateway manager |
| JMS Engine | Structured Message handling |
| 3^{rd} Party SIP/PSTN | Telephony/VOIP handling |
| Gateway | |

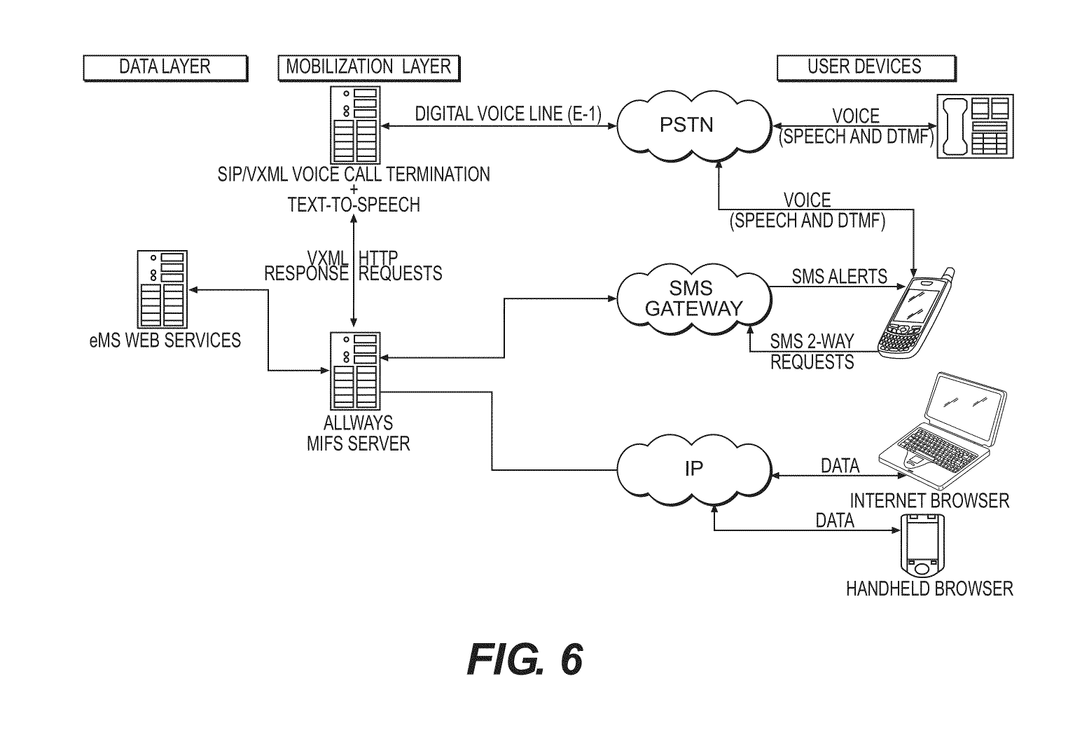

FIG. 6 shows an overview an exemplary deployment of the iAllways platform. In the Data Layer, Web Server runs iAllways Platform components, as a web application. The platform provides the termination of data/voice/wireless requests runs the notification services, has integration with an SMTP gateway and a third-party SMS Gateway.

In the Mobilization Layer, Voice Termination Server runs SIP/VXML IVR software along with Text-To-Speech (TTS) and Automated Speech Recognition (ASR) services.

PSTN/SIP gateway that provides VOIP capability and the integration to traditional public switched telephone networks (PSTN) networks.

A brief description of the Configuration and Deployment Process is provided herein.

Implementing an iAllways Mobilization Solution involves configuring the solution definitions (using iConfigAllways) and deploying the solution package to iAllways Application server (using iDeployAllways)

Role of iConfigAllways
1. Representing the business wrapper
   a. Information Set (elements of information to process, Information Requests and Views)
   b. Target Usergroup representations (sourced from existing Enterprise User Management/Application User Management)
   c. Defining the catalogue of Contexts (Service Contexts on which the end user experiences need to be serviced)
2. Mapping the Data representation
   a. Mapping the information requests to backend requests (Enterprise Application Resources can be exposed as standardized WebService Calls, or Database Object Calls or Specific Custom API Calls—this requires additional implementation of Custom iAccess DSIM)
3. Defining an iAllways Solution Package
   a. Defining EUS service representations by wrapping the Information Requests in context, creating service modes, channel specific data, and schedules (EUS can be of types Portal, Notification and Triggered)
   b. Mapping the related services around a context
   c. Personalization
4. Packaging Personal Workspace(PWS) for Deployment
   a. Define Usergroup level PWS
   b. Permissions for EUS
   c. Usergroup level Personalization of EUS

Once these steps are complete an iAllways Mobilization Solution is ready to deploy.

Role of iDeployAllways
1. Validating the iAllways Mobilization Package
2. Creating iAllways Application Package (Objects, settings and customizations)

The following scenarios will require customization on the deployed solution:
1. Custom Data source integration iAccessDSIM contain generic adaptors for accessing data from SOAP based Web service, RPC based Web service, ODBC connectible Databases, Connector to IMAP enabled Mail Servers, Connector for Messaging and generic File system adaptor. In the case of Datasource access being some custom format for which adaptor is not existing, it needs to be implemented separately
2. Custom Presentation formats iAllways Application server implements generic templates for presenting data and navigation to End User and devices. If there is some specific customization required w.r.t. navigation, branding and custom look and feel and etc., it needs to be implemented using Custom Template Definitions of iAllways Mobilization Platform

Since, the configuration process used in majority of iAllways Mobilization Solution implementation is either through tools or through automations, there is no need to implement the solution in one whole lifecycle. Instead solution can be implemented as and when demand raises in the business.

Exemplary Implementation of iAllWays Mobilization

iAllWays Mobilization Solution is a detailed exemplary implementation of aspects of the disclosed teachings. The steps involved in implementation of iAllWays Mobilization Solution is described herein. Detailed descriptions of Solution Structure, Configuration Process (Configuration Data Definition, Roles and Responsibilities of People involved, and How to's of various steps in Configuration process) and deployment considerations are provided herein. As noted, this merely an exemplary implementation and should not be construed to be limiting in any way.

As noted above, iAllways Mobilization Platform (hereafter referred as IAW) helps providing Enterprise Users Contextual Experiences, across multiple channels (eMail, SMS, Voice, Browsers and etc) in multiple modes (pull, push and on-demand)—cutting across devices, delivery forms and resources. iAllWays Mobilization Solution (hereafter referred as IAW Solution) makes consuming existing Enterprise Systems & Resources—Data, Applications, Processes, Workflows and etc—through well defined configuration data. That configuration data is then transformed and deployed in IAW as IAW Solution.

Implementing an IAW Solution involves the following steps:—
Configuration of an IAW Solution
   Creating a Business Wrapper
   Defining Mobilization Experiences
   Integration of Business Wrapper Requests to Enterprise Resources
   Packaging Solution
Deployment of an IAW Solution
   Deployment Package creation
   Integration
      Enterprise Resource Integration
      End User Service Experience Presentation Customization
      Integration of 3^{rd} Party sub-systems
   Hosting the Solution

For following and implementing these steps IAW provides tools and guidelines. Two major tools are:—

iConfigAllWays—for creating and defining an IAW Solution

iDeployAllWays—for creating the deployment package out of the configuration information. The following table provides a description of some of the terms that are used in IAW

| Term | Description |
|---|---|
| User | Enterprise Systems Consumer can be a specific User or User |
| | Type, IAW doesn't have any exclusive Users, only the Users in |
| | Enterprise Business are referenced to IAW |
| Information | Organizing Information (Enterprise Data/Process in Context) |
| Mobilization | with focus for specific User Interactions agnostic to the form of |
| (Mobilization) | presentation and or delivery |
| Mobilization Use Case | A Use Case describing the information, communication and |
| | action needs of a specific User or for a specific Business Process/ |
| | Workflow |
| User Experience | Contextual Experience delivered to the User through/in access |
| | points |
| Service Context | Context in which the User's Experience requirements are |
| (Context) | identified, in other words business information, communication, |
| | and action needs are grouped |
| End User Service(EUS) | Enterprise Content and Actions scoped for delivery of a Service |
| | Context, IAW has three different EUS types Portal, Notification |
| | and Triggered, with further classification based on whether meant |
| | for Information Access from or Information Update to, the |
| | Enterprise Resource, or IAW implemented Server Actions |
| Edge | User touch point devices like Desktop PC, Mobile PC, Mobile |
| | Phones and application interfaces (like browser, mail clients, on- |
| | device applications) in them |
| Multi-Channel | Across different delivery/presentation channels reaching users |
| | through their Edge devices |
| Multi-Modal | Mode of delivery of Context from IAW |
| | Pull (User consumes Context from system) |
| | Push (system provides Context to User) |
| | On-demand (User requests Context from system |
| | asynchronously) |
| Channel | Medium through which User and IAW Interact with each other |
| Portal Channels | Desktop PC Browser, Mobile Browser, Voice Browser |
| Notification Channels | SMS, Email, Outbound Voice Alert |
| Trigger Channels | SMS, Email, Outbound Voice Alert |
| PC Channel | Desktop PC Browser(s) |
| MB Channel | Mobile Browser implemented in Mobile Phone Handset |
| VB Channel | Voice Browser implemented in Voice Server |
| SMS Channel | Short Messaging Service available in Mobile Phone Handset |
| Email Channel | Email communication/message client in any internet enabled |
| | device |
| OV Channel | Outbound Voice message delivered to voice mail box(es) or |
| | delivered as part of another channel like Email Channel delivery |
| Enterprise Data | Existing IT Systems(Software Applications) and |
| (Enterprise Resource) | Processes(Workflows and Operations) implemented in an |
| | Enterprise |
| Business Wrapper | Representation of Business Views for Information Mobilization |
| | made of Information Sets, User Groups and Service Contexts |
| Information Set | Meta description representation of Entities in the Enterprise |
| | Resources. This is not a Data Representation or Schema, and |
| | constitute the metadata (attributes) description of existing |
| | Structured or Un-Structured data representing Entity in Enterprise |
| | Resources |
| Domain | Business Functions of an Enterprise categorized under a specific |
| | operational grouping, for example Sales, Services, Personnel |
| | Management, Pre-Sale Operations and etc |
| System-to-User | Contextual experiences presented to the User by System(IAW) |
| User-to-System | Contextual experiences accessed by the User from System(IAW) |
| Personal Work Space | Contextual experiences grouped for a specific User/User Type |
| (PWS) | (group) |
| PowerPlay | Orchestration of a set of Contextual Experiences with primary |
| | focus on bringing together Communication, Information and |
| | People relative to the Context |
| Primary Service | Initial EUS Experience provided to the User when a Context is |
| | delivered or accessed |
| Secondary Service | Follow-up or additional EUS Experiences presented to the User |
| (Related Services or | after the Context is provided to the User |
| Related Experiences) | |

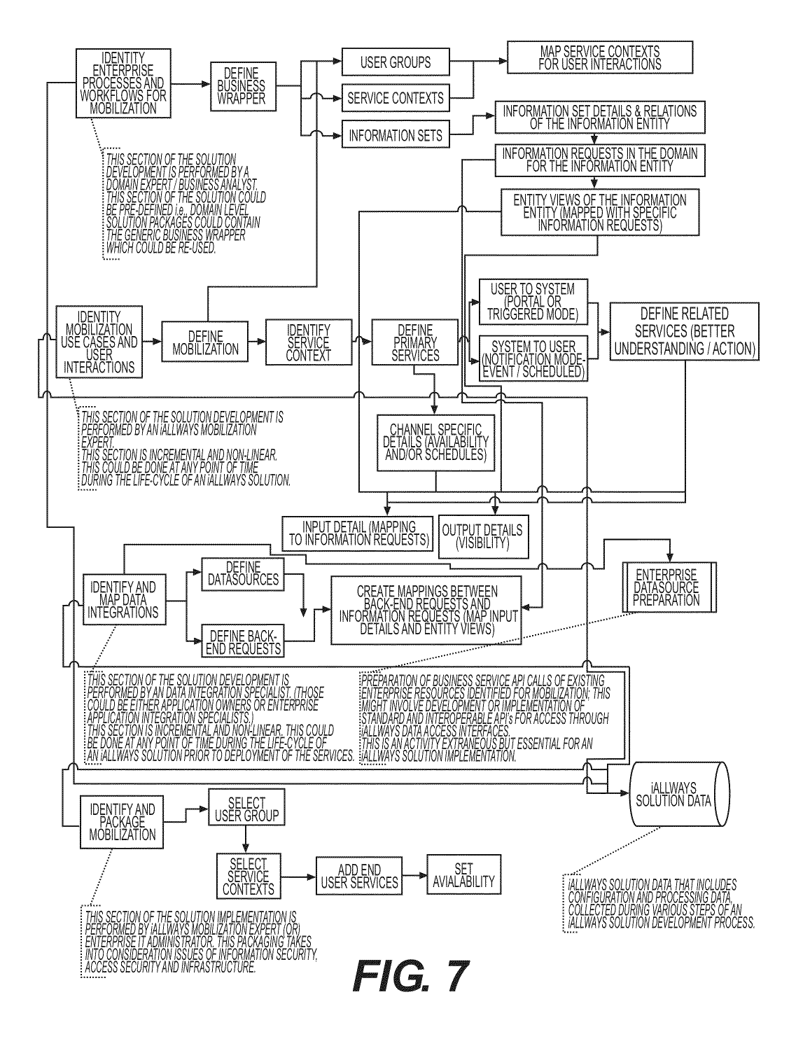

FIG. 7 shows a block diagram that illustrates configuration of an IAW solution

An iAllWays Solution Configuration involves the following steps:—
1. Defining Business Wrapper
2. Configuring Mobilizations
3. Configuring Integration details with Enterprise Resources
4. Packaging IAW Solution

High-level elements (part of the Solution Structure) that make up an IAW Solution and People who are involved in defining and configuring are described in the following two tables.

### People Involved and Responsibilities

| Role | Description | Responsibilities |
|---|---|---|
| Domain Expert | Person(s) with knowledge about | Identifying relevant Information Sets |
| | functions and operations of the | Creating Information Entities and |
| | Enterprise Requirements to be | Representative Views and defining |
| | mobilized | relevant Information Requests for |
| | | Mobilization |
| | | Identifying target User Groups |
| | | Identifying and Creating set of |
| | | Service Contexts in the specific |
| | | Domain for Mobilization |
| Mobilization Expert | Person(s) with knowledge and | Identifying relevant End User |
| | expertise in IAW and | Services for a specific Context, and |
| | mobilization concepts | related Experiences |
| | | Creating and Defining End User |
| | | Service Experiences |
| | | Mapping the details of Primary |
| | | Service and Secondary Services |
| Solution Package | Person(s) with knowledge about | Validate End User Services from |
| Administrator | Information Security and or | Information Security and Network |
| | Network Security knowledge of | Security perspective |
| | the Enterprise to validate and | Add/Remove End User Services |
| | set the permissions to the User | from the PWS of User Group |
| | Group Packages defined in an | Set channel level access permissions |
| | iAllWays Mobilization Package | for End User Services in PWS from |
| | | Security and Infrastructure |
| | | availability standpoints |
| Data Integration | Person(s) with knowledge and | Identifying and Defining Datasource |
| Specialist | or ownership of the Enterprise | Defining Backend Requests available |
| | Resources to be mobilized | in Enterprise Resources |
| | | Mapping the Backend Requests and |
| | | IR schemes defined part of Business |
| | | Wrapper |

### Elements of an IAW Solution

| Element Name | Detailed Description |
|---|---|
| UserGroup | User groups for the mobilization implementation |
| | UserGroup's are target audience for the iAllways Mobilization Solution |
| | Implementation |
| | UserGroup can be identified either based on the Mobilization Use Cases |
| | or can be the starting point of a Solution i.e., an IAW Solution can be |
| | based on the information mobilization needs of a specific UserGroup |
| | UserGroup(s) could also be identified on the participants' categorization |
| | in a ServiceContext |
| | UserGroup(s) belongs to the Enterprise Resources and they are used as |
| | reference in IAW. In other words if there is a need for newer kind of |
| | UserGroup it should be first defined in the respective Enterprise |
| | Backend System and then referred in IAW Solution |
| ServiceContext | Context in which EUS Experiences are mobilized |
| (Context) | Service Context is based on the information(data, related information, |
| | and people) and communication(interfaces, connection to people) |
| | needs of a User to perform a Business Function. That Business Function |
| | can be Workflow, Activity, or Task, which are part of everyday work life |
| | of the User |
| | A specific event or activity happening during the lifecycle of a Business |
| | Process in the Enterprise (either in existing IT Systems or in the flow of |
| | Business) could constitute a Context for the User, where the Enterprise |
| | needs to provide the User with information and communication, this is |
| | the case of System Aligning the User with itself |
| | User initiating/participating in an Business Function will have |
| | differential information and communication needs based on the |
| | particular state or stage of Business, this also constitutes a Context for |
| | the User, this is the case of User Aligning the System with herself |
| | Servicing the Context involves bringing together of Initial Information, |
| | Related Information (for Better Understanding), Related Actions (for |
| | Actioning) through a set of well-defined Services (which can be either |
| | defined in the same Context or being consumed from a related Context) |
| InfoEntity (Information | IAW metadata representation of Information available on the domain |
| Entity) | Info Entity is based on and subsets of classification, of the Information |
| | Sets in a Domain |
| | InfoEntity is metadata collection representing a Entity or group of |
| | Entities in the Enterprise |
| | There can be relationship between InfoEntity with in IAW, this is not |
| | strictly existing Data/Entity Relationships alone, but newer |
| | Relationships are possible based on the Contextual Perspective too |
| | Not all attributes of an Entity in the Enterprise Resource need to be |
| | described as metadata in IAW InfoEntity, only relevant pieces need to be |
| | defined |
| InfoRequest (IR) | Information Requests are used for sourcing data from the back-end |
| | systems |
| | InfoRequest are basic Queries defined part of InfoEntity to shape data |
| | values from Enterprise Resource |
| | InfoRequest generally provides the necessary hooks between the actual |
| | Enterprise Resource and IAW InfoEntity |
| | Also IAW implements its own Server Actions as IAW System |
| | Info Requests |
| | InfoRequests are of three types |
| | Information Access (providing access to information from the |
| | Enterprise Resource) |
| | Information Update (providing hook for updating information in |
| | the Enterprise Resource) |
| | Server Action (implementing Communication Actions-like |
| | Sending Email, Setting up various PSTN hooks and Sending SMS - |
| | and PowerPlay) |
| | An IAW InfoEntity represents an actual Enterprise Entity by metadata, |
| | not all data values of an Enterprise Entity are required by IAW at every |
| | point of execution, and they would be specific to the needs of a EUS. IR |
| | provides the way for addressing differential information needs in IAW. |
| | IR can also be construed as a Business Method Call/Query in IAW to |
| | source the data element(s) from the Enterprise Resource for specific |
| | needs of a Context |
| | Part of the IR definition is definition of Input Parameters, these are |
| | arguments required for processing a BER (if required) in the Enterprise |
| | Resource |
| | In case of the BER requiring arguments to execute an Enterprise |
| | Resource, IR transforms the parameters-through either User Input on |
| | EUS execution or defaulted values part of EUS definition |
| | Output values on execution of the BER is assigned to Entity View |
| | wherever BER is having output |
| EntityView | Visual representation views grouped from the IAW InfoEntity |
| (Visual Rep) | EntityView is grouping of specific attributes of an IAW InfoEntity |
| | EntityView acts as a descriptive holder of output values returned from |
| | execution of an IAW IR |
| | EntityViews are defined part of an IAW InfoEntity and they belong to |
| | that; if that has Relationships with other then those Related InfoEntity |
| | elements can also be used for defining EntityView |
| PortalService | EUSs accessed by the User through portal channels |
| | PortalService is a type of EUS for providing contextual experiences in |
| | Portal Channels |
| | PortalService is for User setting her Context in the System by accessing a |
| | Portal Channel or switching from current Operational Context - which is |
| | either delivered to her or accessed by her |
| | A Portal Service can be either be a Primary Service or Secondary Service |
| | Portal Service can be experienced from the following channels:- |
| | PC Channel |
| | VB Channel |
| | MB Channel |
| | Portal Service definitions include: |
| | Input Requirements for channel for the IAW IR which forms the |
| | base for the EUS |
| | Output Visibility for channel based on the EntityView elements |
| NotificationService | EUSs delivered by the system to the User in Notification |
| | Channels |
| | NotificationService is a type of EUS for providing contextual |
| | experiences in Notification Channels |
| | NotificationService can be either alert message or notification |
| | based on Event (an Event occurring in the Enterprise which is broadcast |
| | to IAW and delivered to user with pre-defined content) or Schedule |
| | (IAW polling Enterprise Resources set in the schedules defined and |
| | delivering content) |
| | Either way Context is set to the User, in other words User is |
| | Aligned to the System |
| | NotificationService can only be a Primary Service and |
| | Secondary Services are from Portal Channels |
| | All Parameter values required by IAW IR on which a |
| | NotificationService is based, should be defined part of IAW Solution, in |
| | other words, there is no User Input for a Notification Service as the |
| | invocation is by IAW |
| | NotificationService can be experienced in the following |
| | channels: |
| | SMS Channel |
| | Email Channel |
| | OV Channel |
| | NotificationService definition includes: |
| | Input Parameter mappings |
| | Output Visibility for channel |
| | Event Details (for Event based) |
| | Schedule Details (for Scheduled) |
| TriggeredService | EUSs triggered by the User |
| | TriggeredService is a type of EUS to provide Contextual Experiences |
| | through Triggered Channels |
| | TriggeredService can be defined either when the User requires |
| | Contextual Experience asynchronously for herself or when she requires |
| | triggering Contextual Experience for others associated in the same |
| | Context so she and the participants can interact |
| | TriggeredService can be invoked/accessed from SMSChannel only |
| | TriggeredServices can be experienced in the following channels: |
| | SMS Channel |
| | Email Channel |
| | OV Channel |
| | TriggeredService definitions include: |
| | SMS Shortcuts for invoking |
| | Input Parameter mapping for SMS Channel |
| | Output Visibility for channel |
| | Delivery Information in case of EUS can be delivered to other |
| | Users by the invoking User |
| Service-to-Service | EUSs related for the Service Context |
| Relations (S2S) | S2S are set of related experiences with respect to the Primary |
| | Service and Context in which it's accessed or delivered |
| | EUSs that make up the S2S are also called Related Services |
| | Related Services are also referred as Secondary Service |
| | Related Services could be from the same Context user is in or |
| | from some other Context |
| | Only Portal Services can be configured as Related Services |
| | S2S can be configured only for Portal Channels and Notification |
| | Channels |
| | S2S are for two purposes |
| | Better Understanding |
| | EUSs which help the User to understand the Context |
| | she is in better |
| | can be to access additional Information |
| | to perform communication and or transactional task |
| | to get better visibility of the Context |
| | Actioning |
| | EUSs which help the User to perform either |
| | communication or transactional task to complete the |
| | Context |
| | If the Related Service requires input parameters for invoking, it |
| | can be mapped from the Primary Service (Input/Output details) or from |
| | Environment Variables; but it's not always a requirement, optionally the |
| | EUS Input Parameters can be User Input during invocation |
| PersonalWorkSpace | PersonalWorkSpace is organized view of Contextual Experiences |
| (PWS) | available for UserGroup |
| | PWS belongs to and defined as part of the UserGroup |
| | UserGroup will have all or some of the Contexts available in a |
| | Mobilization Use Case or Domain depending on level of participation |
| | and requirements |
| | EUSs defined in associated Contexts can be part of the PWS depending |
| | on Information Security and or Network Security rules and policies of |
| | the Enterprise |
| | Similarly S2S - Secondary Service - availability is based on the same |
| | decision making mechanism; i.e., based on the availability of a |
| | particular Context or EUS it will be part of the Related Services in the |
| | PWS |
| | PWS defined for the UserGroup will be available for the Users belonging |
| | to it |
| | Personalization of PWS by User is Changing/Replacing the details of a |
| | EUS by the User, not all EUS and their details are personalizable, |
| | generally it falls under following categories: |
| | Input Parameters |
| | Output Details |
| | Availability (Enabling/Disabling) in a Channel |
| | Only Portal and Triggered Services are Personalizable |
| Environment Variables | Environment Variables are System Variables defined as part of an IAW |
| (EV) | Solution |
| | EV are variables can be either Fixed (value pre-defined in the IAW |
| | Solution) or Computed (value can be computed by IAW on runtime on |
| | its own or sourced from the Enterprise Resource through IR) |
| | EV can be used as Default Values whenever Input Parameter |
| | (arguments) in the following IAW Solution Elements: |
| | BER |
| | IR |
| | EUS |
| | EV Definition includes: |
| | Scope of EV |
| | Value |
| DataSource (DS) | DataSource is representation of Enterprise Resource access information |
| BackEndRequest(BER) | BackEndRequest is actual representation of API Calls available in the |
| | Enterprise Resource for a specific DataSource |
| | BER provides the hook between IR and the Enterprise Resource |
| | BER is the last mile between Enterprise Resources and IAW |
| | Mapping between IR & BER should be configured to get an IAW Solution |
| | working |
| | BER could be either standards based (kinds of Web service, ODBC, |
| | Messaging Queue and etc) or non-standard(Unstructured Data, Events |
| | and etc) |
| | In the case of standards based BER, IAW provides Data Source |
| | Integration Module(DSIM) a kind of Data Adaptors, which could then |
| | use the mapping to make the call to Enterprise Resource whenever IR is |
| | executed |
| | In the case of non-standards based BER, a Custom DSIM needs to be |
| | implemented in IAW to complete the call during Integration phase of |
| | Deployment Process |

Herein we describe how a Business Wrapper is defined. Business Wrapper is the core of an IAW Solution. It is defined, based on either the target Enterprise Domain or the identified Mobilization Use Cases. It could also be defined based on a specific set of Business Functions and also based upon the Information Mobilization needs of a set of Users in an Enterprise.

In an IAW Solution Business Wrapper is made up of InfoEntities, UserGroups and ServiceContexts. Defining a Business Wrapper can be accomplished in two steps:—
Planning
Detailing

### Planning a Business Wrapper

| Step | Description | |
|---|---|---|
| Identify | Method | Example |
| Mobilizations | Existing | Customer Visit |
| Use Cases | activities in an | Sales Review |
| | Enterprise | Order Shipment |
| | Domain | Workflow |
| | | Assignments |
| | Based upon | Regional Sales |
| | specific User | Manager requiring Weekly Performance (Target vs. Actual) |
| | needs | Information and ability to interact with Sales Persons |
| | | Field Service |
| | | Engineer requiring Contract Details, ability to check Part |
| | | availability, ability to initiate Quote Generation workflow |
| | | and ability to interact with Knowledge Management |
| | | (People and Data) |
| | By reviewing | SLA Breach Alert |
| | implemented | Use Case of a Service Organization |
| | Enterprise IT | Service Engineer |
| | Systems and | Field Visit Assignments Use Case |
| | their Use Cases | Equipment |
| | | Monitoring and Maintenance |
| | Extending | Travel Plan |
| | functionality of | Approval |
| | workflow or | Quick Order |
| | process in an | Customer Queries |
| | Enterprise | & Communications |
| | through | |
| Identify the | Sales Review mobilization will require | |
| Information and | Information on Sales Person, Order Aggregation, Promotional Details, | |
| Communication | Customer Information and Communication details for Sales Person, | |
| Requirements | Reviewer | |
| for the | SAL Breach Alert mobilization will | |
| Mobilization | require Information on Customer, Service Complaint, Qualified Service | |
| Use Case | Personnel, Current Assignments and Communication details for Service | |
| | Personnel, Service Manager and Customer | |
| Identify | Direct visibility | Weekly Sales |
| Contexts based | | Review |
| on the | | Customer Site Visit |
| Mobilization | Grouping | Assuming a Sales Person has following activities: |
| Use Cases | together | Task allocated |
| | activities of the | Setting up |
| | User | appointment with Customer |
| | | Promotion |
| | | campaign participation |
| | | Travel planning |
| | | Communication |
| | | with Customer Contact |
| | | Reviewing Customer |
| | | Order and Payment History |
| | | Reviewing Customer |
| | | Pending Order statuses |
| | | Reviewing Customer |
| | | Queries and Issues |
| | | All these activities are part of the work life, but the |
| | | information and communication requirement will vary |
| | | based on whether she is visiting ‘New Customer’, ‘Existing |
| | | Customer’ or ‘Irate Customer’ with these it's possible to |
| | | see the following contexts: |
| | | Post-sale Customer |
| | | Visit |
| | | Pre-sale Customer |
| | | Visit |
| | | Ongoing Order |
| | | Management |
| | | Calendar |
| | | Management |

| | |
|---|---|
| Identify | There are two ways of accomplishing this: |
| Information Sets | Entities on the specific Domain |
| | For example, Sales Domain can have |
| | Customer, Sales Person, Regional Sales Manager, Order, Order |
| | History, Customer Payment History and etc |
| | Based on the Mobilization Use Cases |
| | For example; if we take the Field Service |
| | Engineer mobilizations it will have SLA Contracts, Service Managers, |
| | Service Issues, Service Engineer, Available Inventory, Knowledge |
| | References, Product Specialists and etc |
| Associate Users | Once the above steps are completed, and reviewing the finalized Mobilization |
| with Service | Use Case will bring visibility of User Groups and their Service Context |
| Contexts | associations |

The process of Detailing is described herein.

Completion of the planning activity will make visible the following Solution Elements—
InfoEntities—based on Information Sets & Information Requirements will help us to detail individual InfoEntity(Members, InfoRequests, EntityViews) and Relations between InfoEntities in the Business Wrapper
UserGroups—identified target audience
ServiceContexts—identified contexts
Association between UserGroups and ServiceContexts

Configuring Mobilizations is Described Herein:

Once a Business Wrapper is available for us, we need to plan for various EUS Experiences that are available part of the IAW Solution. Parts of this activity are selecting a Context to mobilize, defining EUS, detailing EUS, configuring EUS relations (S2S relationships).

The detailed steps are
1. Select Context
2. Identify the best way to service the User in the Selected
   Context
      a. System provides Context to User (NotificationService)
         i. Based on an Event occurring in the Enterprise
         ii. Based on pre-defined Schedule
      b. User sets the Context of the System
         i. User can experience through Portal (PortalService)
         ii. User will invoke the experience (TriggeredService)
3. Configure the Primary Service for the Context
   a. Select the appropriate IR from Business Wrapper
   b. If Portal Service
      i. Determine in which Portal Channels this experience can be presented, following points need to be considered:—
         1. Based on the kind of detailing User expects—for example, providing large number of multiple row information in a MB Channel or VB Channel is not optimal, where as a simple ‘Form View’ kind of single row or limited number of rows detail even with multiple columns will be elegant in those channels.
         2. But this could be based on type of Context, some might be purely Data where as others might be minimal Data and Communication. As a general rule of thumb we can provide aggregation information in all Portal Channels and keep the details of the aggregation available in PC Channel.
         3. Another factor to consider is the difference between various channels for Enterprise Requirements like Authentication, Branding, General Access Security and etc.
      ii. Configure Channel level InputParameters (if IR has InputParameter requirement)
         1. Determine whether User Input is required or can be overridden in the EUS definition itself
         2. For each InputParameter determine whether it needs to be an User Input or can be overridden at EUS definition
      iii. Configure Channel level OutputField Visibility (if IR has associated EntityView)
         1. Based on the Channel capability configure which EntityView fields are visible or not.
   c. If Notification Service
      i. Determine in which Notification Channels can be delivered, the following points need to be considered:—
         1. SMSChannel is good enough for delivering simple message alerts
         2. EmailChannel can be used for delivering Information details of the same alert
         3. OVChannel can be used for delivering more detailed and personalized form of the unstructured or communication Messages with minimal Information.
         4. For example, a new Service Issue Logged could be delivered in SMS Channel as alert, with details of the Issue delivered in Email Channel, similarly, during non-working hours the same message can be delivered in OVChannel with contact details for the concerned Customer, with details delivered in EmailChannel.
      ii. Configure InputParmeters (if IR has InputParameter requirement), in Notification Service there is no possibility of User Input on EUS Execution, so all InputParameters should be defaulted to pre-defined values
      iii. Configure Channel level OutputField Visibility, this should be determined based on the conclusions arrived at Step a
      iv. Provide Event Details or Schedule based on type of Notification
   d. If TriggeredService
      i. Configure the InputParameters (if IR has InputParameter requirement), it should be noted that a TriggeredService can be invoked only from SMSChannel, so the constraints of that channel needs to determine the number of User Inputs, majority of the InputParmeters should be defaulted and only instance invocation required should be left as User Input
      ii. Define SMS Shortcuts for invocation
      iii. Configure Channel level OutputField Visibility
4. Determine whether the Context requires additional information after the Primary Service is experienced by the User (NOTE: It's not always necessary to perform this fully or this can be performed partly, sometimes the related requirements might not be visible in a Context, can be determined only after User starts experiencing)
   a. Whether User needs to understand the Context in much more detail i.e., require related Information and or Communication to proceed with his activity (Better Understanding) or needs to perform an Action—Transactional Action and or Communication.
      i. Select the appropriate PortalServices from the same Context or related Contexts, if the PortalService is not defined already, then perform Step 2(a) & 2(b)
      ii. Map the InputParmeters of the RelatedService from Primary Service (we can use any of InputParameters, OutputFields, EnvironmentVariables). It's not necessary that RelatedService should have all InputParameters mapped; but if an appropriate RelatedService is selected it will share Information Scope with the Primary Service, so by default there will be larger scope for mapping. For example, EUS Weekly Sales Report (containing details of Individual Regional Sales Aggregation could have Information about respective Sales Account Managers) will map to EUS Sales Manager Performance for Better Understanding in straight forward manner.

Configuring Integration Details with Enterprise Resources are Describe Herein:

An IAW Solution cannot function in isolation, it enables Contextual view of the existing Enterprise Resources, blends Information and Communication for the Context, and delivers Multi-Channel and Multi-Modal Contextual Experiences. Though at the point of defining Business Wrapper and configuring Mobilizations we are not looking at the Enterprise only through the existing/available Resources, to get the IAW Solution as deployable we need to configure Integration Information with them.

Depending on the level of our knowledge at the time of defining Business Wrapper, this activity could become simple to complex. But we can overcome this easily and without affecting our IAW Solution Deployment overly by creating static Data and test the Experiences; later as the details for Integration viz., Connection Type, Method of Access, API Type and Specifications, and relevant Data Integration Layers are worked out, we can configure the actual Integration.

This activity requires participation of Experts from the Enterprise IT or Application Owners with us at Planning phase and once the modalities of the Integration is worked out, we can configure the details as part of the IAW Solution.

Planning Phase Will Involve the Following Steps:
Determine our Datasource requirements
   This is generally based on Business Wrapper where we can determine based on the Information Sets, identify the specific Data sources.
   But this might also involve getting Data from multiple IT Systems (for example, we might have single representation of Customer Entity in our Business Wrapper which depending on the User's Context needs to be sourced from a CRM System and Calendar Management Application), in this case either we need to clearly identify our required Data sources and resolve the problem by implementing an Intermediate Layer which addresses the merging or complex logical processing and keep that as Datasource or if it is not possible do the Integration with multiple back-end systems.
   Whatever be the approach, we need to clearly identify the relevant Enterprise Resources for our implementation.
Get the Integration details for each Datasource
   Type of the Datasource (for example Web Service, Database, Message Queue, Application API, Event Publisher and etc)
   Connection Information (for example, endpoint and ports for Web Service, connection details for Database and etc)
   Security Requirements (for example, Authentication, Data Security Mechanisms and etc)
   Access Interfaces (for example, WSDL for Web Service, Stored Procedure Library or Query Library for Database and etc)
   Test the Interfaces
Depending on the usability of the Datasource determine whether it's ready for direct consumption or you are going to implement Intermediate Layers (If we decide to build a Intermediate Layer then that would be our Datasource rather than the original back-end Enterprise Resource, at this stage we need to put together our Intermediate Layer's Interfaces and proceed further, and take care of the actual Implementation of that layer during Deployment Process)
   Detailing phase is configuring the information during the planning phase as part of our IAW Solution, this involves following steps:
1. Define Datasource
   a. Datasource Type Information
   b. Connection Information
   c. Security Information
2. Define BackEndRequests for the Datasource
   a. Interface Type Information
   b. Arguments/Parameters (if available)
   c. Output Values/Result (if available)
3. Configure mapping between IR & BER
   a. Select IR to map
   b. Map IR Input Parameters to Parameters (if required)
   c. Map Output Values to IR (associated EV) OutputFields (if available)

The process of Packaging IAW Solution is described herein:

Packaging IAW Solution is mostly an activity with minimal effort and simple but has major impact on the way User experiences the Context. This also involves know-how of the Enterprise for the following details:
Infrastructure perspective will determine what kind of experiences are possible (for example, an Enterprise could limit Voice access to only middle to senior management level Users or only to Users who are working outside the Enterprise Locations, in this case the Contextual Experiences using Voice channel implementations should be restricted only to available Users)
Network Security Perspective will determine where the experiences can be delivered or presented (for example, an Enterprise might restrict access to certain type of Data from being accessed outside its Intranet, in this case a delivered Context might contain Related Experience which is currently out-of bound to the User)
Information Security Perspective will determine the level of detail that can be part of a Context (for example, an Enterprise might have policy restriction on accessing certain type of data for certain User types, in this case a presented or delivered Context might not be fully comprehensible to the User, so alternate EUS with proper detailing should be worked out)

Generally to Package an IAW Solution, we need to work with Enterprise Network and System Persons and understand the policies and rules. Then Plan the limit or availability of individual EUS and Channels. The best way would be to get these details and use this when we plan our Mobilization—i.e., Contextual Experiences and S2S. But depending on the value of Contextual Experience to the User by that way to Enterprise, it might consider relaxing or re-formulating such policies. Though this should not restrict our thinking of Context during Mobilization at the detail level we should see what the possible impact items are and then discuss with the Enterprise during Packaging.

Based on the details we gathered, can proceed with configuration steps:
1. Select UserGroup
2. Select Context
   a. Determine which EUSs in the selected Context are eligible for the User
   b. Determine whether they are available at the Context automatically or User will decide the availability during Personalization

On completion of this activity, we have our IAW Solution ready for deployment. We can do these configuration activities incrementally, as the level of understanding and level of available details progress.

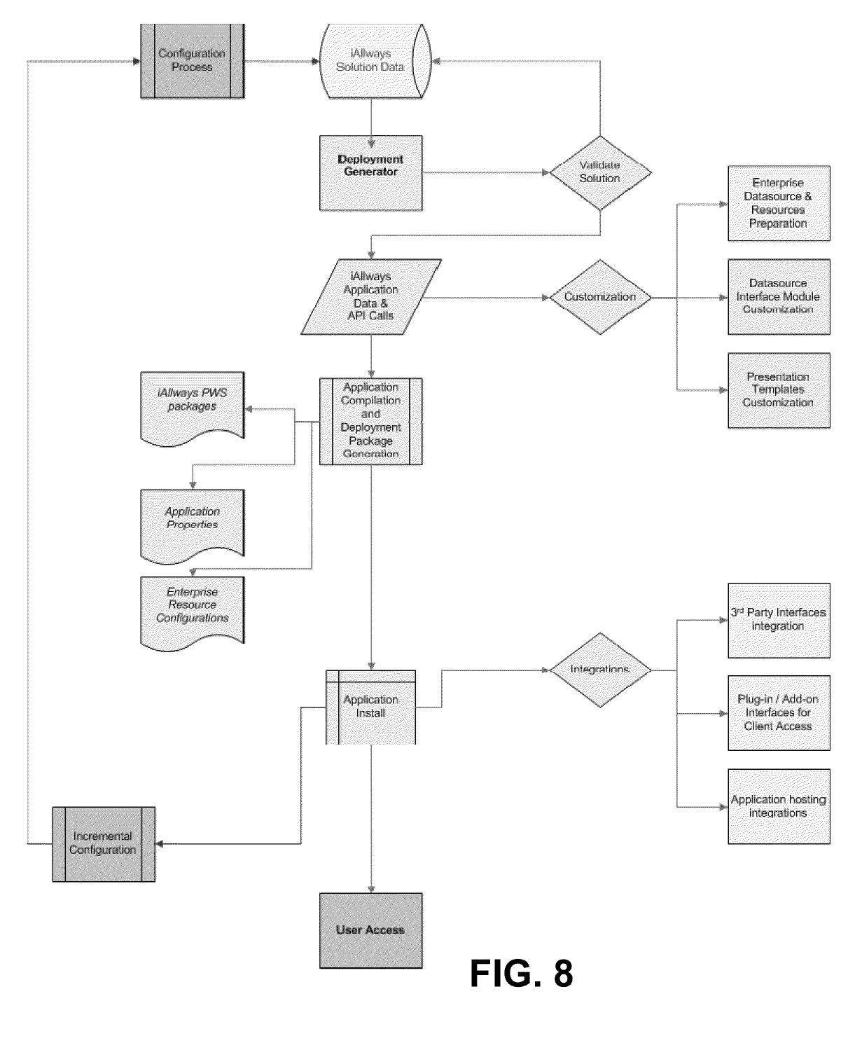

FIG. 8 shows a flowchart illustrating an exemplary example of the deployment process.

Most of the aspects and activities of Deployment Process are provided by IAW, some of those have an impact on Implementation of an IAW Solution. Detailing those is outside the scope of this document, so we will the major areas to consider, details of which are available in other iAllWays Resources:
Datasource Integration
   Customization of Datasource
      Decision on implementing Intermediate Layer
      Security Implementations for Datasource Access from IAW
   Preparation of Datasource
   Validating Datasource
   Performance Testing of Datasource
Template Customization
   Branding of Input Dialogs
   Branding of Presentation Templates
   Implementing newer Templates
3^{rd} Party System Integrations
   Implementing and Integrating with Voice Server
   Implementing Mobile Gateway
   Implementing Integration with Email Servers
Hosting Server
Plug-in, Add-on Implementation
   Device Client
   Integration with Portals
Security Systems Integration
   User Management/Identity Management System
   Secured Gateway

The following Table provides details that need to be Configured by Solution Configurator(s) during Configuration Phase.

| | | |
|---|---|---|
| Attribute Name | Description of the Attribute | Sample or Possible Values |

InfoEntity (Information Set for the Domain)

| | | |
|---|---|---|
| Name | Name of the Information Entity | Customer Information, |
| | | Order Information |
| Description | Description of the Information Entity | |

EntityMember (Members of the Information Entity)

| | | |
|---|---|---|
| Name | Name of the Member element of | Customer Name, |
| | Information Entity | Customer Status, |
| | | Order ID |
| Description | Description of the Member | |
| DataType | Datatype of the Member | |
| | String | |
| | Numeric | |
| | Date | |
| | Boolean | |
| | Custom | |
| RelatedEntity | Related Information Entity if | Customer Member of |
| | Member's Datatype is Custom | OrderInformation Entity is |
| | | CustomerInformation |
| RelatedEntityMember | Member on which the Relationship is | CustomerMember of |
| | visible | OrderInformation Entity |
| | | is related to |
| | | CustomerID of |
| | | CustomerInformation Entity |

EntityView (Visual Representation view of Information Entity)

| | | |
|---|---|---|
| Name | Name of the Entity View | CustomerBaseInformationView |
| | | OrderHeaderInformationView |
| Description | Description of the Entity View | |

Field (Information Entity Members scoped from the Information Entity)

| | | |
|---|---|---|
| Name | Name of the Field - a Member of the | CustomerID, CustomerName, |
| | Information Entity | CustomerContactInformation |
| Description | Description of the Field | |
| Alias | Alias Name that should be used for | Customer Code, |
| | presentation purposes | Customer Business Name |

InformationRequest (Requests for sourcing content from Enterprise Data source)

| | | |
|---|---|---|
| Name | Name of the Information Request | GetCustomerInformation, |
| | | GetOrderInformation |
| Description | Description of the Information Request | |
| Type | Type of the Information Request | |
| | Information Access (Purpose of | |
| | this Request is to get content | |
| | from the back-end resource) | |
| | Information Update (Purpose of | |
| | this Request is to update content | |
| | to the back-end resource) | |

Parameter (Parameters for processing Information Request)

| | | |
|---|---|---|
| Name | Name of the Parameter | CustomerID |
| Description | Description of the Parameter | |
| IsRequired | Whether the Parameter is Required for | True or False |
| | execution at higher level services | |
| DataType | Datatype of the Member | |
| | String | |
| | String {1 of n} | |
| | String {m of n} | |
| | Numeric | |
| | Numeric {1 of n} | |
| | Numeric {m of n} | |
| | Custom | |
| | Date | |
| | Boolean | |
| Prompt | Prompt for the Input Dialog to be | “Enter CustomerID” |
| | presented to the User when Service | “Select from List of Cities” |
| | represented by it is executed | |
| DefaultValue | Value for assignment in case of | UserID |
| | defaulting of the parameter. It should | CurrentDate |
| | be one of the Environment Variables | |
| | available within Solution | |

ServiceContext (Contexts catalogue)

| | | |
|---|---|---|
| Name | Name of the ServiceContext | CustomerVisit |
| | | Serv iceIssueLogged |
| | | SalesReview |
| | | WeeklySalesReview |
| | | EquipmentFailureAlert |
| Description | Description of the ServiceContext | |

UserGroup (UserGroups/target Audience Users)

| | | |
|---|---|---|
| Name | Name of the UserGroup | SalesManager |
| | | ServiceManager |
| | | AccountManager |
| | | SalesPerson |
| Description | Description of the UserGroup | |
| ServiceContexts | ServiceContexts associated with the | For a ServiceManager |
| | UserGroup | ServiceIssueLogged |
| | | EquipmentFailureAlert |
| | | WeeklyReview |
| | | IncidentAlert |

Page (ServiceContext Page with Selected Services)

| | | |
|---|---|---|
| Name | Name of the ServiceContext | |
| Service | Name of the EUS | |
| Title | Titel of the EUS in this Page, generally | |
| | this EUS. Title attribute but can be | |
| | changed | |
| Enabled | Whether the EUS is Enabled or | True or False |
| | Disabled | |

PortalService (PortalService EUS)

| | | |
|---|---|---|
| Name | Name of the PortalService | EUS- |
| | | GetCustomerInformationForCurrent |
| | | Contact |
| Description | Description of the PortalService | |
| Title | Titel of the PortalService | |

PCChannelInputParameter (PortalService PCChannel Input Parameter)

| | | |
|---|---|---|
| IsInputRequired | Whether Input Dialog needs to | True or False |
| | presented to the User for Input | |
| Name | Name of the IR Input Parameter | |
| Description | Description of the Input Parameter | |
| IsUserInput | Whether part of Input Dialog | True or False |
| DefaultValue | If already assigned at IR added here | |
| | and can be overridden else configured | |
| | here | |

PCChannelVisibleFields (PortalService PCChannel Output Visibility)

| | | |
|---|---|---|
| Name | Name of the EV Field | |
| Enabled | Whether visible | True or False |

MBChannelInputParameter (PortalService MBChannel Input Parameter)

| | | |
|---|---|---|
| IsInputRequired | Whether Input Dialog needs to | True or False |
| | presented to the User for Input | |
| Name | Name of the IR Input Parameter | |
| Description | Description of the Input Parameter | |
| IsUserInput | Whether part of Input Dialog | True or False |
| DefaultValue | If already assigned at IR added here | |
| | and can be overridden else configured | |
| | here | |

MBChannelVisibleFields (PortalService MBChannel Output Visibility)

| | | |
|---|---|---|
| Name | Name of the EV Field | |
| Enabled | Whether visible | True or False |

VBChannelInputParameter (PortalService VBChannel Input Parameter)

| | | |
|---|---|---|
| IsInputRequired | Whether Input Dialog needs to | True or False |
| | presented to the User for Input | |
| Name | Name of the IR Input Parameter | |
| Description | Description of the Input Parameter | |
| IsUserInput | Whether part of Input Dialog | True or False |
| DefaultValue | If already assigned at IR added here | |
| | and can be overridden else configured | |
| | here | |

VBChannelVisibleFields (PortalService VBChannel Output Visibility)

| | | |
|---|---|---|
| Name | Name of the EV Field | |
| Enabled | Whether visible | True or False |

RelatedService (Related Services for the Portal Service)

| | |
|---|---|
| Name | Name of the Related Service |
| Description | Description of the Related Service |
| Service | Secondary Service EUS |
| ServiceContext | Service Context of the Related Service |

MappingParameter (Related Services Mapping Parameter with the Portal Service)

| | |
|---|---|
| ServiceParameter | InputParameter of the Related Service |
| ValueParameter | Mapping Paramter either from Primary |
| | Service InputParameters, OutputFields |
| | or EnvironmentVariables |

NotificationService (NotificationService EUS)

| | | |
|---|---|---|
| Name | Name of the NotificationService | EUS_NewIssueLoggedAlert |
| Description | Description of the NotificationService | |
| Title | Titel of the NotificationService | |

InputParameter (NotificationService Input Parameters)

| | |
|---|---|
| Name | Name of the IR Input Parameter |
| Description | Description of the Input Parameter |
| DefaultValue | If already assigned at IR added here |
| | and can be overridden else configured |
| | here from EnvironmentVariables |

SMSChannelVisibleFields (NotificationService SMSChannel Output Visibility)

| | | |
|---|---|---|
| Name | Name of the EV Field | |
| Enabled | Whether visible | True or False |

EmailChannelVisibleFields (NotificationService EmailChannel Output Visibility)

| | | |
|---|---|---|
| Name | Name of the EV Field | |
| Enabled | Whether visible | True or False |

OVChannelVisibleFields (NotificationService OVChannel Output Visibility)

| | | |
|---|---|---|
| Name | Name of the EV Field | |
| Enabled | Whether visible | True or False |

EventDetails (NotificationService Event Details if EUS is Event Based)

| | | |
|---|---|---|
| EventName | Name of the Event occurring the | Order Shipped |
| | Enterprise Resource | CalendarChanged |
| Description | Detailed Description of the Event with | |
| | information for connecting and | |
| | conditions | |

ScheduleDetails (NotificationService Scheduling Details if EUS is Scheduled)

| | | |
|---|---|---|
| IsServiceLevelSchedule | Whether part of overall Schedule for | True or False |
| | the Solution or specific to the | |
| | NotificationService | |
| TypeOfSchedule | Possible Scheduling Categories | |
| | Hourly | |
| | Daily | |
| | Bi-Weekly | |
| | Weekly | |
| | Fortnightly | |
| | Monthly | |
| | Quarterly | |
| DetailsOfSchedule | Based on the possible Scheduling Type | |
| | further details on the Day, Time and | |
| | Specific Day(number of Day) | |
| IsTimeZoneSpecific | Whether the EUS polling should be | |
| | specific to User's TimeZone | |
| IsDelayedDelivery | Whether the EUS delivery has to take | |
| | into account individual User's delay | |
| | requirements | |
| PreferredServerTime | Preferred Server Time to execute if | |
| | Delayed Delivery | |
| PreferredLocalTime | Preferred Local Time to deliver if | |
| | Delayed Delivery | |

RelatedService (Related Services for the Notification Service)

| | |
|---|---|
| Name | Name of the Related Service |
| Description | Description of the Related Service |
| Service | Secondary Service EUS |
| ServiceContext | Service Context of the Related Service |

MappingParameter (Related Services Mapping Parameter with the Notification Service)

| | |
|---|---|
| ServiceParameter | InputParameter of the Related Service |
| ValueParameter | Mapping Paramter either from Primary |
| | Service InputParameters, OutputFields |
| | or EnvironmentVariables |

TriggeredService (TriggeredService EUS)

| | | |
|---|---|---|
| Name | Name of the TriggeredService | EUS_DeliverDailyReportTo |
| Description | Description of the TriggeredService | |
| Title | Titel of the TriggeredService | |
| TriggerShortcuts | Trigger Shortcut assigned for invoking | |
| | the EUS from SMSChannel | |
| DeliveryToOthersPermitted | Whether the TriggeredService can be | True or False |
| | delivered other than the invoking User | |
| DeliveryParameter | Depending on TriggeredChannel to | |
| | deliver additional InputParameters, | |
| | should be Key-Value Pair | |
| | MobileNumber: Value | |
| | EmailId(s): Value | |
| IsInputRequired | Whether User needs to provide Input | True or False |
| | during Invoking, will depend based on | |
| | other settings | |

InputParameter (TriggeredService Input Parameters)

| | | |
|---|---|---|
| Name | Name of the IR Input Parameter | |
| Description | Description of the Input Parameter | |
| IsUserInput | Whether part of Input Dialog during | True or False |
| | invoking | |
| DefaultValue | If already assigned at IR added here | |
| | and can be overridden else configured | |
| | here from EnvironmentVariables | |

SMSChannelVisibleFields (TriggeredService SMSChannel Output Visibility)

| | | |
|---|---|---|
| Name | Name of the EV Field | |
| Enabled | Whether visible | True or False |

EmailChannelVisibleFields (TriggeredService EmailChannel Output Visibility)

| | | |
|---|---|---|
| Name | Name of the EV Field | |
| Enabled | Whether visible | True or False |

OVChannelVisibleFields (TriggeredService OVChannel Output Visibility)

| | | |
|---|---|---|
| Name | Name of the EV Field | |
| Enabled | Whether visible | True or False |

DataSource (Datasource representing the actual Enterprise Resource

| | |
|---|---|
| Name | Name of the Data source |
| Description | Description of the Data source |
| Type | Type of the Data source, possible |
| | values include |
| | Web service |
| | Database |
| | Mail Server |
| | Message Queue |
| | Event Publisher |
| | File System |
| | Other Custom API |
| ConnectionDetail | Connection Detail for the Data source |
| AdditionalDetail | Security and Integration Properties of |
| | the Data source |

BackEndRequest (Back-end Request - Interfaces and Access Methods available in the
Datasource)

| | | |
|---|---|---|
| Name | Name of the BER | |
| Description | Description of the BER | |
| Datasource | Name of the associated Datasource | |
| Type | Type of the access interface | WebMethod |
| | | Stored Procedure |
| | | Inbox IMAP Method |
| Instructions | Instructions and details for accessing | |
| | this interface in Enterprise Resource | |
| Request | Sample Request Signature for the | |
| | Interface in Enterprise Resource | |
| Response | Sample Response Output for the | |
| | Interface in Enterprise Resource | |

RequestParameter (Request Parameter/Arguments of the BackEndRequest)

| | | |
|---|---|---|
| Name | Name of the Request Parameter | |
| Description | Description of the Request Parameter | |
| DataType | Data Type of the Request Parameter - | |
| | should be actual Data Type in the | |
| | Interface not the marshalled type in | |
| | IAW | |
| IsRequired | Whether the Request Parameter is | True or False |
| | optional or required in the Interface | |
| DefaultValue | If the RequestParameter can be | |
| | defaulted by Constant Value at IAW, | |
| | then should be assigned from | |
| | Environment Variables | |

ResponseValue (Response/Result/Output Values of the BackEndRequest)

| | |
|---|---|
| Name | Name of the ResponseValue |
| Description | Description of the ResponseValue |
| DataType | DataType of the Response Value - |
| | should be actual Data Type in the |
| | Interface not the marshalled type in |
| | IAW |

BackEndRequestMapping (Mapping between IR and BER) - Part of InfoRequest

| | |
|---|---|
| InformationRequest | Information Request |
| DataSource | DataSource |
| BackEndRequest | BackEndRequest |
| ProcessingInformation | Additional Information required for |
| | processing this mapping, should |
| | include marshalling and conditions, |
| | can be provided as Text (no particular |
| | format) |

RequestMappingParameter (Mapping between IR Input Parameters and BER Request
Parameters)

| | |
|---|---|
| SourceItem | IR Input Parameter as Source |
| TargetItem | BER Request Parameter as Target |

EntityViewMappingField (Mapping between IR's associated EV Fields and BER
ResponseValues)

| | |
|---|---|
| SourceItem | EV Field Parameter as Source |
| TargetItem | BER Response Value as Target |

EnvironmentVariable (System Variables defined as part of the Solution to assign Default
Values)

| | | |
|---|---|---|
| Name | Name of the EnvironmentVariable | |
| Description | Description of the Environment | |
| | Variable | |
| Type | Type of the Environment Variable | |
| | Fixed | |
| | Computed | |
| Scope | Scope of the Environment Variable | |
| | (used by IAW during runtime for | |
| | determining scope) | |
| | System | |
| | Session | |
| | User | |
| IsCached | Whether the EnvironmentVariable is | True or False |
| | Cached by IAW during runtime | |
| DataType | Data Type of the Environment | |
| | Variable | |
| | String | |
| | String List | |
| | Numeric | |
| | Numeric List | |
| | Boolean | |
| | Date | |
| | Custom | |
| Value | Incase of the Constant Value(s), | |
| | otherwise Key: Value mapping with | |
| | delimeter “\|\|” | |

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. An enterprise mobilization system comprising:
EUS which receives user requirement and translates the requirement into a content component and platform independent delivery component; and
DSIM which receives an information tree based on the content component and translates it into requests for data from at least one data source,
wherein the information is contextualized
wherein the system provides an ability to take actions based on the context wherein all user experiences related to the mobilization are achieved through the concept of end-user services.
